(19) United States
(12) Patent Application Publication
(10) Pub. No.: US 2025/0341901 A1
(43) Pub. Date: Nov. 6, 2025

(54) TRANSLATION PEN

(71) Applicants: BEIJING BOE DISPLAY TECHNOLOGY CO., LTD., Beijing (CN); BOE TECHNOLOGY GROUP CO., LTD., Beijing (CN); BEIJING BOE TECHNOLOGY DEVELOPMENT CO., LTD., Beijing (CN)

(72) Inventors: Dapeng LIANG, Beijing (CN); Yaxin SUN, Beijing (CN); Peng ZHONG, Beijing (CN); Feng LONG, Beijing (CN); Xiuyun CHEN, Beijing (CN); Donghua WANG, Beijing (CN); Jing ZHAO, Beijing (CN); Yujie LIU, Beijing (CN)

(21) Appl. No.: 18/994,938

(22) PCT Filed: May 14, 2024
(86) PCT No.: PCT/CN2024/093178

§ 371 Date: Jan. 15, 2025

(30) Foreign Application Priority Data
Jun. 29, 2023 (CN) 202310781361.3

(51) Int. Cl. G06F 3/0354; G06F 3/038; H04N 23/52; H04N 23/56; H04N 23/57

(52) U.S. Cl. CPC G06F 3/03542; G06F 3/0383; H04N 23/52; H04N 23/56; H04N 23/57

(57) ABSTRACT

The present disclosure provides a translation pen, including: a body mechanism; a display mechanism; a rotation mechanism including first rotation assembly and second rotation assembly, where an axial direction of rotating shaft of second rotation assembly is the same as an axial direction of body mechanism, an axial direction of rotating shaft of first rotation assembly is intersected with the axial direction of the rotating shaft of the second rotation assembly, and the rotation mechanism is configured to: allow the display mechanism to rotate along the rotating shaft of the first rotation assembly, and allow the display mechanism to rotate along the rotating shaft of the second rotation assembly; a camera mechanism where the camera mechanism in second state is located outside the body mechanism; and a pen head mechanism connected to the body mechanism, where the camera mechanism in the second state is arranged toward the pen head mechanism.

### TECHNICAL FIELD

The present disclosure relates to a field of an electronic device technology, and in particular, to a translation pen.

### BACKGROUND

A translation pen is an intelligent terminal product that integrates an optical character recognition (OCR) technology, a machine translation technology and a speech synthesis technology. A working process of the translation pen includes: first collecting an image of a paper document by the OCR technology, recognizing text in the image to obtain a source language text, and then translating the source language text by the machine translation technology to obtain a target language text, and finally playing out the target language text in a form of speech by the speech synthesis technology. The process may also be called a scanning-reading process. The current translation pen uses an integrated design and provides a poor use experience.

### SUMMARY

In order to at least partially solve the above-mentioned technical problems, the present disclosure provided a translation pen.

According to an aspect of the present disclosure, a translation pen is provided, including: a body mechanism, including a first end and a second end opposite to each other; a display mechanism; a rotation mechanism, including a first rotation assembly and a second rotation assembly connected to the first rotation assembly, where the first rotation assembly is connected to the display mechanism, the second rotation assembly is connected to the first end of the body mechanism, an axial direction of a rotating shaft of the second rotation assembly is the same as an axial direction of the body mechanism, an axial direction of a rotating shaft of the first rotation assembly is intersected with the axial direction of the rotating shaft of the second rotation assembly, and the rotation mechanism is configured to: allow the display mechanism to rotate along the rotating shaft of the first rotation assembly relative to the body mechanism, and allow the display mechanism to rotate along the rotating shaft of the second rotation assembly relative to the body mechanism; a camera mechanism on a side surface of the body mechanism, where a state of the camera mechanism includes a first state and a second state, the camera mechanism in the first state is located inside the body mechanism, and the camera mechanism in the second state is located outside the body mechanism; and a pen head mechanism connected to the second end of the body mechanism, where the camera mechanism in the second state is arranged toward the pen head mechanism.

According to embodiments of the present disclosure, the display mechanism includes a first surface and a second surface opposite to each other, and a display screen is provided on the first surface; and the first rotation assembly is connected to the second surface, and the display mechanism and the body mechanism are foldable and deployable along the rotating shaft of the first rotation assembly; where when the display mechanism and the body mechanism are in a folded state, the body mechanism is located on a side of the second surface away from the first surface, and in a thickness direction of the body mechanism, an orthographic projection of a top end of the pen head mechanism does not overlap an orthographic projection of the second surface.

According to embodiments of the present disclosure, when the display mechanism and the body mechanism are in the folded state, an orthographic projection of the body mechanism on the second surface is spaced apart from an orthographic projection of the first rotation assembly on the second surface, and a distance between a surface of the body mechanism away from the display mechanism and the display mechanism is greater than a distance between an axis of the rotating shaft of the first rotation assembly and the display mechanism.

According to embodiments of the present disclosure, the rotation mechanism further includes a support frame, the first rotation assembly includes a first shaft body and a second shaft body, and the second rotation assembly includes a third shaft body; the first shaft body and the second shaft body are fixedly connected to the display mechanism, and the third shaft body is fixedly connected to the body mechanism; and at least one of the first shaft body, the second shaft body, and the third shaft body is rotatably connected to the support frame by a damper bearing, where the first shaft body and the second shaft body are located on two opposite sides of the support frame respectively, and the third shaft body is located on a different side of the support frame from the first shaft body and the second shaft body.

According to embodiments of the present disclosure, the first end of the body mechanism includes a first inclined portion, a thickness of the first inclined portion gradually decreases in a direction pointing from the second end toward the first end, a side of the first inclined portion away from the second end abuts the display mechanism when the display mechanism and the body mechanism are in a deployed state, and the body mechanism is substantially parallel to the display mechanism.

According to embodiments of the present disclosure, the damper bearing is embedded in the support frame; and the damper bearing and the support frame are formed into an integral structure; or the damper bearing and the supporting frame are fixedly connected by a buckle structure.

According to embodiments of the present disclosure, at least one of the first shaft body, the second shaft body, and the third shaft body includes a protrusion portion, the protrusion portion protrudes into the damper bearing and forms an interference fit with the damper bearing.

According to embodiments of the present disclosure, the body mechanism includes a third surface and a fourth surface opposite to each other, a first opening is provided on the third surface, and the translation pen further includes: a first switch in the first opening, where a distance between a top end of the first switch and the fourth surface is less than or equal to a distance between the third surface and the fourth surface; and a locking member in the body mechanism, where the locking member is connected to the first switch; where the first switch is configured to drive the locking member to unlock the camera mechanism in response to a pressing operation, so as to allow the state of the camera mechanism to switch from the first state to the second state.

According to embodiments of the present disclosure, the camera mechanism includes a camera base and a camera, and the camera is embedded in the camera base; the camera base includes a third end and a fourth end opposite to each other, the fourth end is rotatably connected to the body mechanism by a third rotation assembly, and the third end is configured to be locked by the locking member; and the third rotation assembly is configured to: allow, when the third end is unlocked from the locking member, the camera base to rotate from an inside of the body mechanism along a rotating shaft of the third rotation assembly until the camera base reaches a designated position outside the body mechanism, so as to switch the state of the camera mechanism from the first state to the second state.

According to embodiments of the present disclosure, the translation pen further includes a first mounting column, where the first mounting column is fixedly connected to an inner surface of the body mechanism, the first mounting column extends in a thickness direction of the body mechanism, and the first switch is sleeved on the first mounting column and movable on the first mounting column in an extension direction of the first mounting column; the locking member includes a fifth end, a sixth end, and a transmission assembly between the fifth end and the sixth end, the sixth end abuts the first switch and is movable between a first predetermined position and a second predetermined position with a displacement of the first switch; and the transmission assembly is configured to: clamp the fifth end to the camera mechanism for locking when the sixth end moves to the first predetermined position, and separate the fifth end from the camera mechanism for unlocking when the sixth end moves to the second predetermined position.

According to embodiments of the present disclosure, the first switch includes: a button, where a front surface of the button is exposed by the first opening, and the first switch is movable to a third predetermined position and a fourth predetermined position in the extension direction of the first mounting column; a first circular truncated cone on a back surface of the button; and a second circular truncated cone on a side of the first circular truncated cone away from the button, and a diameter of the second circular truncated cone is less than a diameter of the first circular truncated cone; and the sixth end abuts the second circular truncated cone and is at the first predetermined position when the first switch is at the third predetermined position, and the sixth end abuts the first circular truncated cone and is at the second predetermined position when the first switch is at the fourth predetermined position.

According to embodiments of the present disclosure, the first mounting column is sleeved with a first elastic member, the first elastic member is elastically connected to the first switch, and the first elastic member is configured to: allow the first switch to move to a fourth predetermined position in the extension direction of the first mounting column when the first switch is pressed, and allow the first switch to move to a third predetermined position in the extension direction of the first mounting column when the press on the first switch is released.

According to embodiments of the present disclosure, the transmission assembly includes a rotating shaft, and the sixth end rotates around the rotating shaft with the displacement of the first switch, so as to move between the first predetermined position and the second predetermined position; and the fifth end rotates around the rotating shaft with a displacement of the sixth end, so as to be clamped to the camera mechanism or to be separated from the camera mechanism.

According to embodiments of the present disclosure, a shape of the pen head mechanism includes a sphere, and a diameter of the pen head mechanism is in a range from 1 mm to 4 mm.

According to embodiments of the present disclosure, the designated position is configured to: allow a viewing angle boundary of the camera to cover a target line of text and an end of a previous line of text of the target line of text close to the target line of text; where the target line of text includes a line of text adjacent to the pen head mechanism and not obscured by the pen head mechanism.

According to embodiments of the present disclosure, the designated position satisfies: θ1=90°−θ2/2−arctan(a/(b−c)); where θ1 represents a first included angle between a horizontal plane where the camera is located and the axial direction of the body mechanism, θ2 represents a viewing angle boundary of the camera, a represents a horizontal distance between the camera and the pen head mechanism, b represents a vertical distance between the camera and a top end of the pen head mechanism, and c represents a configurable value, where a range of value of c is from 6.5 mm to 8 mm.

According to embodiments of the present disclosure, the body mechanism includes a main board and a contact switch, the pen head mechanism is movable between a fifth predetermined position and a sixth predetermined position in the axial direction of the body mechanism; the main board includes a main control module and a fill light control circuit electrically connected to the main control module, the camera mechanism further includes a fill light lamp, and the fill light lamp is electrically connected to the fill light control circuit; the main control module is configured to: output a first control signal to the fill light control circuit when the translation pen is woken up; the pen head mechanism is electrically connected to the contact switch, and the contact switch is configured to: output a second control signal to the light fill control circuit when the pen head mechanism moves to the fifth predetermined position; and the fill light control circuit is configured to: control the fill light lamp to be turned on when the first control signal and the second control signal are received.

According to embodiments of the present disclosure, a convex portion and a second elastic member at least partially surrounding the convex portion are provided between the pen head mechanism and the contact switch; and the second elastic member is configured to: when an external pressure is applied to the pen head mechanism, allow the pen head mechanism to move to the fifth predetermined position and bring the convex portion into contact with the contact switch, so that the contact switch outputs the second control signal to the fill light control circuit; and when the external pressure is relieved, restore the pen head mechanism to the sixth predetermined position.

According to embodiments of the present disclosure, the contact switch is further configured to: output a third control signal to the main control module when the pen head mechanism is pressed into the fifth predetermined position; and the main control module is further configured to: wake up the camera mechanism in response to the third control signal, so as to start an acquisition of an image; and confirm a completion of the acquisition in response to an interruption of the third control signal.

According to embodiments of the present disclosure, the camera mechanism further includes a camera, a divergence angle of the fill light lamp is greater than or equal to 100°, and a distance between the fill light lamp and the camera is greater than or equal to 0.8 mm.

According to embodiments of the present disclosure, the main board further includes: a wireless communication module electrically connected to the main control module, a power management module, a storage module, and a first adapter, the wireless communication module is located on a different side of the main board from the main control module, and the power management module, the storage module and the first adapter are located on a same side of the main board as the main control module; the display mechanism includes a screen drive board, the screen drive board includes a display drive circuit and a second adapter electrically connected to the display drive circuit, and the display drive circuit and the second adapter are located on a same side of the screen drive board; and the first adapter is electrically connected to the second adapter by an adapter harness.

According to embodiments of the present disclosure, the power management module provides a first power supply voltage and a second power supply voltage, a magnitude of the first power supply voltage is different from a magnitude of the second power supply voltage; the screen drive board further includes: a level compatible circuit connected between the second adapter and the display drive circuit; and the level compatible circuit is configured to: provide one of the first power supply voltage and the second power supply voltage to a pull-up power supply of a data signal and a clock signal in the display drive circuit and a communication power supply of the main control module.

According to embodiments of the present disclosure, in an axial direction of the display mechanism, the second adapter is located on a side of the display drive circuit close to the rotation mechanism, and the level compatible circuit is located on a side of the display drive circuit far away from the second adapter.

According to embodiments of the present disclosure, the main board further includes a camera mechanism connector, and the camera mechanism connector is electrically connected to the camera mechanism by a flexible circuit board; and the flexible circuit board includes at least one bending region, the bending region includes a grid structure, and a material in the bending region includes a rolled copper.

According to embodiments of the present disclosure, the flexible circuit board further includes a non-bending region outside the bending region, a wiring is provided on a side surface of the bending region, and a wiring is provided on each of two side surfaces of the non-bending region.

According to embodiments of the present disclosure, the at least one bending region includes a first bending region and a second bending region, the second bending region is located between the first bending region and the camera mechanism, and a bending angle of the first bending region is greater than a bending angle of the second bending region; the body mechanism further includes a fixing structure fixedly connected to an inner surface of the body mechanism, the main board further includes a second opening, the second opening is configured to expose the fixing structure, and the first bending region is fixedly connected to the fixing structure by the second opening; and where the fixing structure includes a first curved surface, and the first curved surface substantially fits the first bending region.

According to embodiments of the present disclosure, the camera mechanism includes a camera, the pen head mechanism includes a pen head, and an optical axis of the camera passes through the pen head when the camera mechanism is in the second state.

### BRIEF DESCRIPTION OF THE DRAWINGS

The above contents and other objectives, features and advantages of the present disclosure may be more apparent through the following descriptions of embodiments of the present disclosure with reference to the accompanying drawings, in which:

FIG. 1 schematically shows one of stereograms of a translation pen according to embodiments of the present disclosure;

FIG. 2 schematically shows a schematic diagram of a rotation mechanism according to embodiments of the present disclosure;

FIG. 3 schematically shows a schematic diagram of rotating along a rotating shaft of a first rotation assembly according to embodiments of the present disclosure;

FIG. 4 schematically shows a schematic diagram of rotating along a rotating shaft of a second rotation assembly according to embodiments of the present disclosure;

FIG. 5A and FIG. 5B schematically show schematic diagrams of folding along a rotating shaft of a first rotation assembly according to embodiments of the present disclosure;

FIG. 6 schematically shows a schematic diagram of a left-hand grip according to embodiments of the present disclosure;

FIG. 7 schematically shows a schematic view of a right-hand grip according to embodiments of the present disclosure;

FIG. 8 schematically shows a schematic diagram of a camera mechanism in a second state according to embodiments of the present disclosure;

FIG. 9 schematically shows a schematic diagram of a camera mechanism in a first state according to embodiments of the present disclosure;

FIG. 10 schematically shows a schematic diagram of a first rotation assembly according to embodiments of the present disclosure;

FIG. 11 schematically shows a schematic diagram of a second rotation assembly according to embodiments of the present disclosure;

FIG. 12 schematically shows a schematic diagram of a camera mechanism in a first state according to embodiments of the present disclosure;

FIG. 13 schematically shows a schematic diagram of a camera mechanism in a second state according to embodiments of the present disclosure;

FIG. 14A schematically shows a schematic diagram of a first switch at a third predetermined position according to embodiments of the present disclosure;

FIG. 14B schematically shows a schematic diagram of a first switch at a fourth predetermined position according to embodiments of the present disclosure;

FIG. 15 schematically shows a schematic diagram of a viewing angle boundary of a camera according to embodiments of the present disclosure;

FIG. 16 schematically shows a circuit diagram of controlling a fill light lamp according to embodiments of the present disclosure;

FIG. 17 schematically shows a circuit diagram of a translation pen according to embodiments of the present disclosure;

FIG. 18 schematically shows a circuit diagram of a fill light lamp according to embodiments of the present disclosure;

FIG. 19 schematically shows a schematic diagram of a pen head mechanism according to embodiments of the present disclosure;

FIG. 20 schematically shows a schematic diagram of providing a first power supply voltage and a second power supply voltage by a power management module according to embodiments of the present disclosure;

FIG. 21 schematically shows a schematic diagram of a flexible circuit board according to embodiments of the present disclosure;

FIG. 22A schematically shows a schematic diagram of a main board, a flexible circuit board and a fixing structure according to embodiments of the present disclosure;

FIG. 22B schematically shows a schematic diagram of fitting a first bending region and a first curved surface according to embodiments of the present disclosure;

FIG. 22C schematically shows a schematic diagram of exposing a fixing structure by a second opening according to embodiments of the present disclosure; and

FIG. 22D schematically shows a schematic diagram of a second opening according to embodiments of the present disclosure.

### DETAILED DESCRIPTION OF EXAMPLES

In order to make objectives, technical solutions and advantages of the present disclosure clearer, the technical solutions in embodiments of the present disclosure will be described below clearly and completely with reference to the accompanying drawings. Obviously, the described embodiments are only some, but not all of the embodiments of the present disclosure. Based on the described embodiments of the present disclosure, all other embodiments obtained by those ordinary skilled in the art without any creative work fall within the scope of protection of the present disclosure.

It should be noted that in the accompanying drawings, a size and a relative size of an element may be enlarged for the purpose of clarity and/or description. Accordingly, the size and the relative size of each element are not necessarily limited to those shown in the accompanying drawings. In the specification and the accompanying drawings, the same or similar reference numerals indicate the same or similar components.

When an element is described as being “on”, “connected to” or “coupled to” another element, the element may be directly on the another element, directly connected to the another element, or directly coupled to the another element, or there may be an intermediate element therebetween. However, when an element is described as being “directly on”, “directly connected to” or “directly coupled to” another element, no intermediate element is provided. Other terms and/or expressions used to describe a relationship between elements, such as “between” and “directly between”, “adjacent to” and “directly adjacent to”, “on” and “directly on”, etc. should be interpreted in a similar manner. Moreover, a term “connection” may refer to a physical connection, an electrical connection, a communication connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other. For the purpose of the present disclosure, “at least one selected from X, Y or Z” and “at least one selected from a group consisting of X, Y and Z” may be interpreted as only X, only Y, only Z, or any combination of two or more of X, Y and Z, such as XYZ, XYY, YZ and ZZ. As used herein, a term “and/or” includes any and all combinations of one or more of the listed related items.

It should be noted that although terms “first”, “second”, etc. may be used herein to describe various parts, components, elements, regions, layers and/or portions, these parts, components, elements, regions, layers and/or portions should not be limited by these terms. Rather, these terms are used to distinguish a part, component, element, region, layer and/or portion from another. Therefore, for example, a first part, a first component, a first element, a first region, a first layer and/or a first portion discussed below may be referred to as a second part, a second component, a second element, a second region, a second layer and/or a second portion without departing from the teaching of the present disclosure.

For the convenience of description, spatial relationship terms, such as “upper”, “lower”, “left”, “right”, etc. may be used herein to describe a relationship between an element or feature and another element or feature as shown in the drawings. It should be understood that the spatial relationship terms are intended to cover other different orientations of an apparatus in use or operation other than those described in the drawings. For example, if the apparatus in the drawings is turned upside down, an element or feature described to be “below” or “under” another element or feature may be oriented to be “above” or “on” the another element or feature.

Terms “substantially”, “about”, “approximately”, “roughly” and other similar terms used herein are used as terms of approximation rather than terms of degree, and they are intended to explain an inherent deviation of a measured or calculated value that will be recognized by those ordinary skilled in the art. In consideration of factors such as a process fluctuation, a measurement problem, an error (that is, a limitation of a measurement system) related to a measurement of a specific quantity, etc., the term “about” or “approximately” used herein includes the stated value and means that the specific value determined by those ordinary skilled in the art is within an acceptable range of deviation. For example, “about” may mean that a value is within one or more standard deviations, or within ±30%, ±20%, ±10% or ±5% of the stated value.

It should be noted that an expression “the same layer” used herein refers to a layer structure formed by forming a film layer for formation of specific patterns through a same film forming process, and then performing a patterning process using a mask. According to different specific patterns, a patterning process may include a plurality of exposure, development or etching processes, and the specific pattern in the formed layer structure may be continuous or discontinuous. That is, a plurality of elements, parts, structures and/or portions located in the “same layer” are made of the same material and formed by the same patterning process. Generally, the plurality of elements, parts, structures and/or portions located in the “same layer” have substantially the same thickness.

Those ordinary skilled in the art should understand that, unless otherwise specified, an expression “height” or “thickness” used herein refers to a size in a direction perpendicular to a surface of each film layer provided on the display substrate, that is, a size in a light emitting direction of the display substrate, or called a size in a normal direction of the display device.

In a comparative example, a translation pen is provided. The translation pen may be integrated with a display screen. When performing scanning-reading using the translation pen, a pen head mechanism of the translation pen covers a text to be translated. A scanning module below the pen head mechanism of the translation pen scans the text to be translated and displays the scanned content on a screen of the translation pen. In the comparative example, the screen of the translation pen is fixedly disposed on a pen body of the translation pen. During the scanning-reading, a relative position between the screen and human eyes is not convenient for a user to observe the screen in a real time, and the user often needs to pick up the translation pen for a head-up viewing on the screen, and then confirm the scanned content. However, when the user picks up the translation pen, the translation pen may have completed a translation action. At this time, if the scanned content is found to be incorrect, the user needs to re-scan the entire content, resulting in a poor use experience.

In view of this, embodiments of the present disclosure provide a translation pen, including: a body mechanism, including a first end and a second end opposite to each other; a display mechanism; a rotation mechanism, including a first rotation assembly and a second rotation assembly connected to the first rotation assembly, where the first rotation assembly is connected to the display mechanism, the second rotation assembly is connected to the first end of the body mechanism, an axial direction of a rotating shaft of the second rotation assembly is the same as an axial direction of the body mechanism, an axial direction of a rotating shaft of the first rotation assembly intersects with the axial direction of the rotating shaft of the second rotation assembly, and the rotation mechanism is used to: allow the display mechanism to rotate along the rotating shaft of the first rotation assembly relative to the body mechanism, and allow the display mechanism to rotate along the rotating shaft of the second rotation assembly relative to the body mechanism; a camera mechanism on a side surface of the body mechanism, where a state of the camera mechanism includes a first state and a second state, the camera mechanism in the first state is located inside the body mechanism, and the camera mechanism in the second state is located outside the body mechanism; and a pen head mechanism connected to the second end of the body mechanism, where the camera mechanism in the second state is arranged toward the pen head mechanism.

Embodiments of the present disclosure provide a translation pen with a display mechanism which may rotate bidirectionally, which is convenient for the user to observe a display content on the display mechanism during the scanning-reading. At the same time, during the scanning-reading, the user may achieve a scanning-reading function without allowing the pen head mechanism to cover a content to be scanned. The camera mechanism (or the pen head mechanism) may neither block the content to be scanned nor block a scanning-reading path. On this basis, a viewing angle range of the camera mechanism may cover the pen head mechanism and an adjacent region of the pen head mechanism, which may avoid a problem of an excessive scanning or a missed scanning caused by an inaccurate acquisition range due to a separation of the camera mechanism and the pen head mechanism, and greatly improve the use experience of the translation pen.

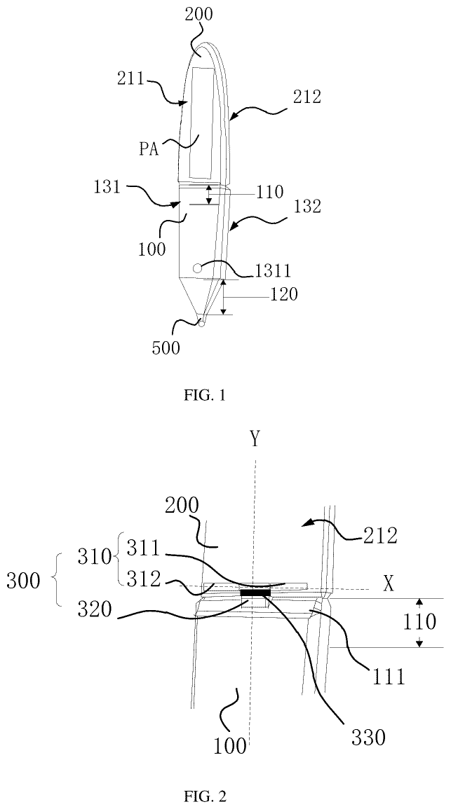

The translation pen of embodiments of the present disclosure will be described below in detail with reference to FIG. 1 to FIG. 22D.

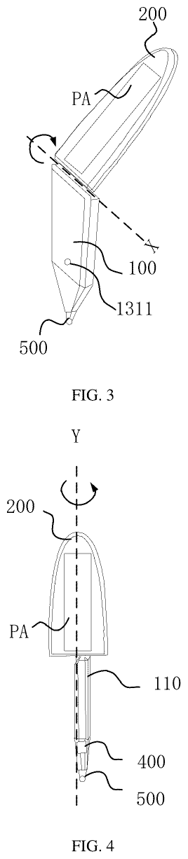

FIG. 1 schematically shows one of stereograms of a translation pen according to embodiments of the present disclosure, FIG. 2 schematically shows a schematic diagram of a rotation mechanism according to embodiments of the present disclosure, FIG. 3 schematically shows a schematic diagram of rotating along a rotating shaft of a first rotation assembly according to embodiments of the present disclosure, and FIG. 4 schematically shows a schematic diagram of rotating along a rotating shaft of a second rotation assembly according to embodiments of the present disclosure

Referring to FIG. 1 to FIG. 4, the translation pen in the embodiments includes a body mechanism 100, a display mechanism 200, a rotation mechanism 300, a camera mechanism 400 and a pen head mechanism 500.

In embodiments of the present disclosure, the body mechanism 100 may include an electronic component used to achieve a core function of the translation pen. For example, the body mechanism 100 may include a main board provided with various control modules and control circuits, and the like. The display mechanism 200 may include a display device used to achieve a display function. For example, the display mechanism 200 may include a display screen PA and a display drive board used to supply a drive signal to the display screen PA.

It should be noted that, although the body mechanism 100 and the display mechanism 200 in FIG. 1 to FIG. 4 have thin and flat structures, this does not constitute a limitation on a shape of the body mechanism 100 and a shape of the display mechanism 200 in embodiments of the present disclosure. For example, the shape of the body mechanism 100 and the shape of the display mechanism 200 may further include a columnar structure, or the like. The specific shape may be specifically determined according to actual needs, and will not be limited in the present disclosure.

It should be also noted that, although the display screen PA of the display mechanism 200 in FIG. 1 to FIG. 4 has a rectangular structure, the display screen PA also has other shapes in embodiments of the present disclosure. For example, a corner of the display screen PA is arc-shaped, or the display screen PA is oval, or even circular, etc.

In embodiments of the present disclosure, the body mechanism 100 includes a first end 110 and a second end 120 opposite to each other. The rotation mechanism 300 includes a first rotation assembly 310 and a second rotation assembly 320 connected to the first rotation assembly 310, where the first rotation assembly 310 is connected to the display mechanism 200, the second rotation assembly 320 is connected to the first end 110 of the body mechanism 100, an axial direction of a rotating shaft of the second rotation assembly 320 is the same as an axial direction of the body mechanism 100, an axial direction of a rotating shaft of the first rotation assembly 310 intersects with the axial direction of the rotating shaft of the second rotation assembly 320, and the rotation mechanism 300 is used to: allow the display mechanism 200 to rotate along the rotating shaft of the first rotation assembly 310 relative to the body mechanism 100, and allow the display mechanism 200 to rotate along the rotating shaft of the second rotation assembly 320 relative to the body mechanism 100.

In embodiments of the present disclosure, for the sake of clarity, embodiments of the present disclosure will be explained below by taking a vertically placed translation pen as an example, unless otherwise specified.

Referring to FIG. 1 to FIG. 4, the translation pen is placed vertically and in a deployed state. The first end 110 and a second end 120 are arranged in an axial direction of the body mechanism 100. The first end 110 is used to mount the display mechanism 200, and the second end 120 is used to mount the pen head mechanism 500. The first end 110 of the body mechanism 100 may refer to an upper end of the body mechanism 100, and the second end 120 of the body mechanism 100 may refer to a lower end of the body mechanism 100. For example, a shape of the second end 120 may include a prism. In the axial direction of the body mechanism 100, the farther the prism is from the second end 120, the smaller a cross-sectional area of the prism. The pen head mechanism 500 may be mounted on a side with a smallest cross-sectional area of the prism.

In embodiments of the present disclosure, the pen head mechanism 500 is retractably connected to the body mechanism 100. The pen head mechanism 500 may be retracted into the body mechanism 100 or extended from the body mechanism 100.

The upper end of the body mechanism 100 is connected to a lower end of the display mechanism 200 by the rotation mechanism 300. An axial direction of a rotating shaft X of the first rotation assembly 310 may include a horizontal direction in FIG. 1 to FIG. 4. An axial direction of a rotating shaft Y of the second rotation assembly 320 may include a vertical direction in FIG. 1 to FIG. 4. That is, the axial direction of the rotating shaft X of the first rotation assembly 310 is perpendicular to the axial direction of the rotating shaft Y of the second rotation assembly 320.

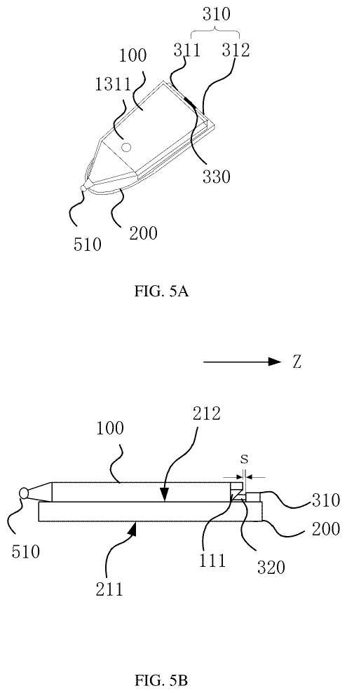

FIG. 5A and FIG. 5B schematically show schematic diagrams of folding along a rotating shaft of a first rotation assembly according to embodiments of the present disclosure.

Referring to FIG. 1 to FIG. 5B, the display mechanism 200 may rotate in two directions of the rotating shaft X and the rotating shaft Y relative to the body mechanism by the rotation mechanism 300. For example, the display mechanism 200 may rotate 180° along the rotating shaft X relative to the body mechanism 100 by the first rotation assembly 310, and the display mechanism 200 may rotate 360° along the rotating shaft Y relative to the body mechanism 100 by the second rotation assembly 320.

That is, in embodiments of the present disclosure, the display mechanism 200 may rotate in two directions relative to the body mechanism 100. In this way, when the user uses the translation pen for the scanning-reading, an angle of the display mechanism 200 may be adjusted at will according to a sitting posture, a visual angle, and the like, so that the user may confirm the scanned content while performing the scanning-reading, and when the scanned content is found to be incorrect, the user may immediately stop and re-scan the content, thereby improving the using efficiency.

Moreover, after the display mechanism 200 rotates 180° along the rotating shaft X relative to the body mechanism 100 by the first rotation assembly 310, the body mechanism 100 and the display mechanism 200 may be folded, which is beneficial to a storage of the translation pen.

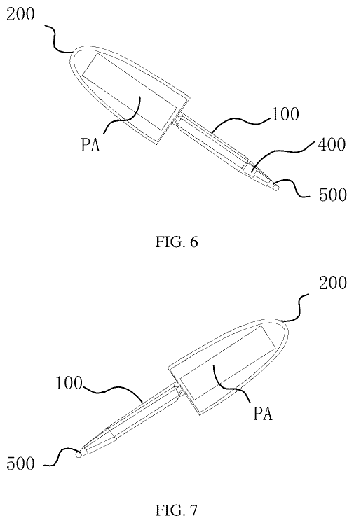

Furthermore, the display mechanism 200 may rotate in two directions, so that the translation pen may support a right-hand grip and a left-hand grip. For example, referring to FIG. 6 and FIG. 7, FIG. 6 schematically shows a schematic diagram of a left-hand grip according to embodiments of the present disclosure; and FIG. 7 schematically shows a schematic diagram of a right-hand grip according to embodiments of the present disclosure.

It should be noted that, in embodiments of the present disclosure, although the rotating shaft of the rotation mechanism 300 in embodiments of the present disclosure will be described by taking a horizontal direction and a vertical direction in FIG. 1 to FIG. 4 as examples, this does not constitute a limitation to embodiments of the present disclosure. For example, an axial direction of the rotating shaft of the rotation mechanism 300 may be any direction intersecting with the horizontal direction or the vertical direction in FIG. 1 to FIG. 4. The specific axial direction may be determined according to actual needs, and will not be limited in the present disclosure.

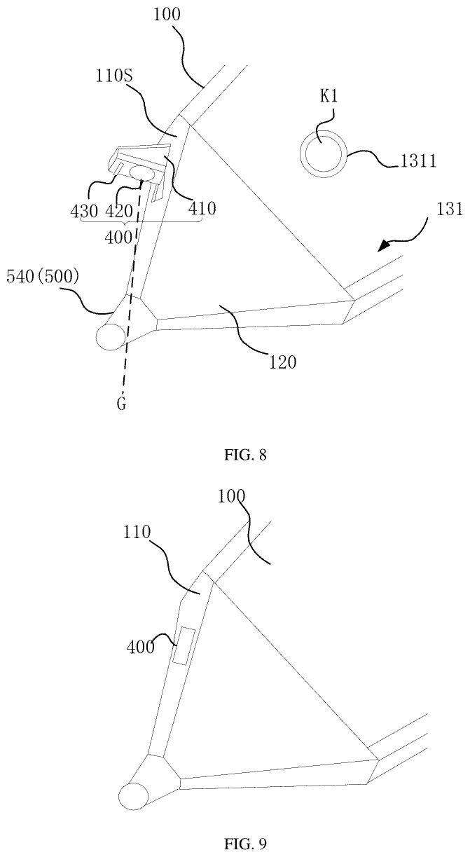

FIG. 8 schematically shows a schematic diagram of a camera mechanism in a second state according to embodiments of the present disclosure; and FIG. 9 schematically shows a schematic diagram of a camera mechanism in a first state according to embodiments of the present disclosure.

In embodiments of the present disclosure, the camera mechanism 400 is located on a side surface 110S of the body mechanism 100. Referring to FIG. 8 and FIG. 9, a state of the camera mechanism 400 includes a first state and a second state, the camera mechanism 400 in the first state is located inside the body mechanism 100, and the camera mechanism 400 in the second state is located outside the body mechanism 100. The pen head mechanism 500 is connected to the second end 120 of the body mechanism 100, and the camera mechanism 400 in the second state is arranged toward the pen head mechanism 500.

In embodiments of the present disclosure, the camera mechanism 400 is not integrated with the pen head mechanism 500, but is located on the side surface 110S of the body mechanism 100. When the user uses the translation pen for the scanning-reading, it is not required to use the pen head mechanism 500 of the translation pen to cover the content to be scanned, but to locate the pen head mechanism 500 of the translation pen below the content to be scanned. In this way, both the camera mechanism 400 and the pen head mechanism 500 may not block the content to be scanned and the path to be scanned during the scanning-reading, which is more beneficial to an observation of the user and more in line with a reading habit of the user.

The pen head mechanism 500 and the display mechanism 200 are located on two opposite ends of the body mechanism 100, respectively. Referring to FIG. 1, the pen head mechanism 500 is located at the lower end of the body mechanism 100, and the display mechanism 200 is located at the upper end of the body mechanism 100.

In embodiments of the present disclosure, the pen head mechanism 500 may be provided with a corresponding function according to actual needs. For example, the pen head mechanism 500 may have functions of touch control, writing, erasing, etc.

In embodiments of the present disclosure, the first state may refer to an off-working state of the camera mechanism 400. At this time, the camera mechanism 400 is accommodated in the body mechanism 100, so as to form a protection for the camera mechanism 400 while reducing a space occupied by the translation pen. The second state may refer to a working state of the camera mechanism 400. In this state, the camera mechanism 400 may move from an inside of the body mechanism 100 to an outside of the body mechanism 100. The movement method of the camera mechanism 400 may include a retractable method, a pop-up method, etc. The camera mechanism 400 moving to the outside of the body mechanism 100 is arranged toward the pen head mechanism 500, so as to collect the content to be scanned in the adjacent region of the pen head mechanism 500.

Therefore, embodiments of the present disclosure provide a translation pen with a display mechanism 200 which may rotate bidirectionally, which is convenient for the user to observe a display content on the display mechanism 200 during the scanning-reading. At the same time, during the scanning-reading, the user may achieve a scanning-reading function without allowing the pen head mechanism 500 to cover a content to be scanned. The camera mechanism 400 (or the pen head mechanism 500) may neither block the content to be scanned nor block a scanning-reading path. On this basis, a viewing angle range of the camera mechanism 400 may cover the pen head mechanism 500 and an adjacent region of the pen head mechanism 500, which may avoid a problem of an excessive scanning or a missed scanning caused by an inaccurate acquisition range due to a separation of the camera mechanism 400 and the pen head mechanism 500, and greatly improve the use experience of the translation pen.

The translation pen in embodiments of the present disclosure will be further described below.

Referring to FIG. 1, FIG. 2, FIG. 5A, and FIG. 5B, in some specific embodiments, the display mechanism 200 includes a first surface 211 and a second surface 212 opposite to each other, and a display screen PA is provided on the first surface. The first rotation assembly 310 is connected to the second surface 212, and the display mechanism 200 and the body mechanism 100 are foldable and deployable along the rotating shaft X of the first rotation assembly 310. When the display mechanism 200 and the body mechanism 100 are in a folded state, the body mechanism 100 is located on a side of the second surface 212 away from the first surface 211, and in the thickness direction of the body mechanism 100, an orthographic projection of a top end 510 of the pen head mechanism 500 does not overlap an orthographic projection of the second surface 212, or an orthographic projection of a top end 510 of the pen head mechanism 500 in a thickness direction of the body mechanism 100 does not overlap an orthographic projection of the second surface 212 in the thickness direction of the body mechanism 100.

In embodiments of the present disclosure, a thickness of the display mechanism 200 is substantially the same as a thickness of the body mechanism 100. For example, both the display mechanism 200 and the body mechanism 100 have a flat structure with a thin thickness, so that after the display mechanism 200 and the body mechanism 100 are folded, an overall thickness thereof may be still thin. Optionally, a thickness range of the display mechanism 200 and the thickness of the body mechanism 100 may be from 6 mm to 8 mm. In this way, after the display mechanism 200 and the body mechanism 100 are folded, the overall thickness thereof is thin and in a range from 12 mm to 16 mm, which is convenient for carrying and storage.

Optionally, a length of the display mechanism 200 is substantially the same as a length of the body mechanism 100. In this way, after the display mechanism 200 and the body mechanism 100 are folded, they may overlap each other, so that an overall length of the folded translation pen may be reduced to half of the length of the translation pen in the deployed state. For example, the length of the body mechanism 100 and the length of the display mechanism 200 may be in a range from 80 mm to 100 mm, and the overall length of the folded translation pen may be in a range from 80 mm to 100 mm, for example, 87 mm.

In embodiments of the present disclosure, after the display mechanism 200 and the body mechanism 100 are folded, the top end 510 of the pen head mechanism 500 protrudes from the display mechanism 200 in the axial direction of the body mechanism 100, and the pen head mechanism 500 may still be in a contact with an outside world, so as to achieve the function of scanning-reading, etc. As mentioned above, the camera mechanism 400 is located on the side surface 110S of the body mechanism 100. In this way, after the folding, a switching of the state of the camera mechanism 400 between the first state and the second state may not be affected. At the same time, the viewing angle range of the camera mechanism 400 in the second state may still cover the pen head mechanism 500 and an adjacent region thereof, so that the translation pen may still achieve a corresponding scanning-reading function in the folded state.

Optionally, a display screen may also be provided on the second surface 212, where the display screen PA on the first surface 211 may be referred to as a main display screen, and the display screen on the second surface 212 may be referred to as a sub-display screen. Both may display corresponding contents respectively according to actual needs.

Referring to FIG. 5B, in some specific embodiments, when the display mechanism 200 and the body mechanism 100 are in the folded state, an orthographic projection of the body mechanism 100 on the second surface 212 is spaced apart from an orthographic projection of the first rotation assembly 310 on the second surface 212. In other words, in embodiments of the present disclosure, a particular gap S is provided between the body mechanism 100 and the first rotation assembly 310 in the axial direction of the body mechanism 100. An orthographic projection of the gap S on the second surface 212 spaces the orthographic projection of the body mechanism 100 on the second surface 212 apart from the orthographic projection of the first rotation assembly 310 on the second surface 212, so that the orthographic projection of the body mechanism 100 on the second surface 212 is spaced apart from the orthographic projection of the first rotation assembly 310 on the second surface 212. On the one hand, the gap S is used for set the second rotation assembly 320, and on the other hand, the gap S reserves a sufficient space for a rotation of the display mechanism 200 along the rotating shaft Y of the second rotation assembly 320.

Optionally, a distance between a surface on a side of the body mechanism 100 away from the display mechanism 200 and the display mechanism 200 is greater than a distance between an axis of the rotating shaft X of the first rotation assembly 310 and the display mechanism 200. In embodiments of the present disclosure, after the display mechanism 200 and the body mechanism 100 are folded, the body mechanism 100 fits a second surface 212 of the display mechanism 200, and the distance between the surface on the side of the body mechanism 100 away from the display mechanism 200 and the display mechanism 200 is approximately equal to the thickness of the body mechanism 100. That is, in embodiments of the present disclosure, the thickness of the body mechanism 100 is greater than the distance between the axis of the rotating shaft X of the first rotation assembly 310 and the display mechanism 200.

In embodiments of the present disclosure, after the display mechanism 200 and the body mechanism 100 are folded, the distance between the axis of the rotating shaft X of the first rotation assembly 310 and the display mechanism 200 is substantially equal to a distance between an axis of the rotating shaft Y of the second rotation assembly 320 and the display mechanism 200. Optionally, after the display mechanism 200 and the body mechanism 100 are deployed, the distance between the axis of the rotating shaft X of the first rotation assembly 310 and the display mechanism 200 is substantially equal to the distance between the axis of the rotating shaft Y of the second rotation assembly 320 and the display mechanism 200. In other words, after the display mechanism 200 and the body mechanism 100 are deployed, the axis of the rotating shaft X of the first rotation assembly 310 is in a same horizontal plane as the axis of the rotating shaft Y of the second rotation assembly 320, and the horizontal plane is parallel to the second surface 212.

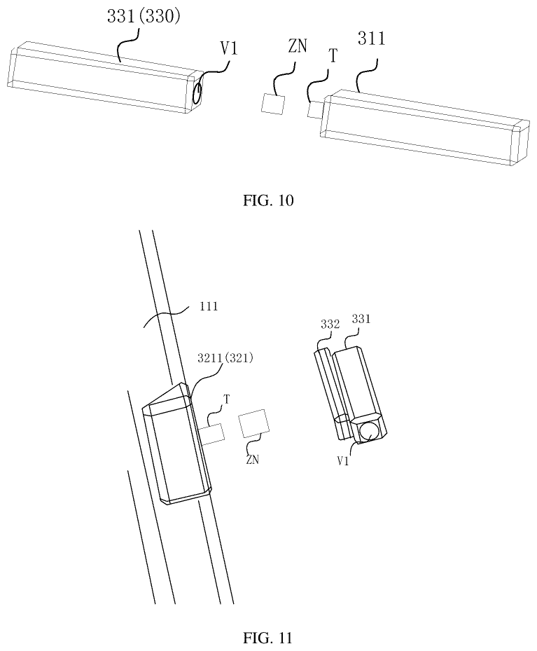

FIG. 10 schematically shows a schematic diagram of a first rotation assembly according to embodiments of the present disclosure; and FIG. 11 schematically shows a schematic diagram of a second rotation assembly according to embodiments of the present disclosure;

Referring to FIG. 2, FIG. 10 and FIG. 11, in some specific embodiments, the rotation mechanism 300 further includes a support frame 330, the first rotation assembly 310 includes a first shaft body 311 and a second shaft body 312, and the second rotation assembly 320 includes a third shaft body 321. The first shaft body 311 and the second shaft body 312 are fixedly connected to the display mechanism 200, specifically, to the second surface 212, and the third shaft body 321 is fixedly connected to the body mechanism 100. At least one of the first shaft body 311, the second shaft body 312, and the third shaft body 321 is rotatably connected to the support frame 330 by a damper bearing ZN. The first shaft body 311 and the second shaft body 312 are located on two opposite sides of the support frame 330, respectively, and the third shaft body 321 is located on a different side of the support frame 330 from the first shaft body 311 and the second shaft body 312. For example, the third shaft 321 is located on an adjacent side of the support frame to the first shaft 311 and the second shaft 312. For example, the support frame 330 is a cuboid, the cuboid includes six side surfaces and each two side surfaces opposite to each other, where two side surfaces are arranged along a long axis of the cuboid, the first shaft body 311 and the second shaft body 312 may be connected to the two side surfaces, respectively, and the third shaft body 321 may be connected to any one of other four side surfaces.

In embodiments of the present disclosure, the first shaft body 311 and the second shaft body 312 are provided coaxially. Referring to FIG. 2, the first shaft body 311 and the second shaft body 312 are located on a right side and a left side of the support frame 330, respectively. A left end of the first shaft body 311 is rotationally connected to a right end of the support frame 330 by the damper bearing ZN, and a right end of the second shaft body 312 is rotationally connected to a left end of the support frame 330 by the damper bearing ZN. Referring to FIG. 2 and FIG. 11, an end of the third shaft body 321 is fixedly connected to the body mechanism 100, and the other end of the third shaft body 321 is rotationally connected to a middle portion of the support frame 330 by the damper bearing ZN.

Optionally, the first shaft body 311 and the second shaft body 312 may include a block-like structure or a strip-like structure. For example, the first shaft body 311 and the second shaft body 312 may use the strip-like structure, so that a contact area between the first shaft body 311 and the second surface 212 of the display mechanism 200 and a contact area between the second shaft body 312 and the second surface 212 of the display mechanism 200 may be increased, so as to improve a stability.

Referring to FIG. 2, FIG. 5B and FIG. 11, in some specific embodiments, the first end 110 of the body mechanism 100 includes a first inclined portion 111, a thickness of the first inclined portion 111 gradually decreases in a direction pointing from the second end 120 toward the first end 110. Optionally, a thickness of a side of the first inclined portion 111 away from the second end 120 may be substantially the same as the thickness of the body mechanism 100, which is convenient for an alignment of the display mechanism 200 and the body mechanism 100 in the deployed state. Referring to FIG. 5B, the direction pointing from the second end 120 toward the first end 110 may refer to a direction Z from left to right in FIG. 5B.

Referring to FIG. 1, FIG. 2 and FIG. 8, when the display mechanism 200 and the body mechanism 100 are in the deployed state, the body mechanism 100 is substantially parallel to the display mechanism 200. In embodiments of the present disclosure, the body mechanism 100 includes a third surface 131 and a fourth surface 132 opposite to each other. The third surface is provided with a first opening 1311 and a first switch K1 embedded in the first opening 1311. The body mechanism 100 being substantially parallel to the display mechanism 200 may indicate that: the second surface 212 may coincide with the third surface 131 (and/or the fourth surface 132) after translating in a thickness direction of the display mechanism 200.

A side of the first inclined portion 111 away from the second end 120 abuts the display mechanism 200 when the display mechanism 200 and the body mechanism 100 are in the deployed state, so that the body mechanism 100 may closely fit the display mechanism 200 after being deployed, thereby reducing a volume of the translation pen in the deployed state.

Referring to FIG. 11, the third shaft body 321 and an inclined surface of the first inclined portion 111 are formed into an integral structure. For example, when a housing of the body mechanism 100 is manufactured, the first inclined portion 111 and the third shaft body 321 are formed synchronously. Optionally, the third shaft body 321 may be fixedly connected to the inclined surface of the first inclined portion 111 by a buckle structure. The body mechanism 100 may closely fit the display mechanism 200 through the first inclined portion 111 when the translation pen is in the deployed state. At the same time, referring to FIG. 5B, the inclined surface of the first inclined portion 111 forms a notch at a position where the display mechanism 200 fits the body mechanism 100, thereby reserving a sufficient space for a connection between the third shaft body 321 and the body mechanism 100.

Optionally, the third shaft body 321 may include a second inclined portion 3211, and the second inclined portion 3211 is fixedly connected to the first inclined portion 111. For example, the third shaft body 321 is provided at a thick end of the second inclined portion 3211 (a right side of the second inclined portion 3211 in FIG. 11). An inclined surface of the second inclined portion 3211 fits the inclined surface of the first inclined portion 111.

In some specific embodiments, the damper bearing ZN is embedded in the support frame 330. The damper bearing ZN and the support frame 330 are formed into an integral structure. Alternatively, the damper bearing ZN and the supporting frame 330 are fixedly connected by the buckle structure.

In embodiments of the present disclosure, three damper bearings ZNs may be embedded in the support frame 330. For example, referring to FIG. 11, the support frame 330 includes a first support portion 331 and a second support portion 332 on the first support portion 331. The first support portion 331 is provided coaxially with the first shaft body 311 and the second shaft body 312. Both a left end and a right end of the first support portion 331 are provided with first mounting holes V1, respectively. Two of the three damper bearings ZNs may be respectively embedded into the first mounting holes V1s at the left end and the right end of the first support portion 331 by the buckle structure. A side of the second support portion 332 far away from the first support portion 331 is provided with a second mounting hole (not shown in the drawings), and the other one of the three damper bearings ZNs may be embedded into the second mounting hole by the buckle structure.

Referring to FIG. 10 and FIG. 11, in some specific embodiments, at least one of the first shaft body 311, the second shaft body 312, and the third shaft body 321 includes a protrusion portion T, and the protrusion portion T protrudes into the damper bearing ZN and forms an interference fit with the damper bearing ZN. For example, each of the first shaft body 311, the second shaft body 312, and the third shaft body 321 includes the protruding portion T. The protruding portions Ts of the three protrude into corresponding damper bearings ZN and form the interference fit with the damper bearings ZN. An extrusion of an outer diameter of the protrusion portion T and an inner diameter of the damper bearing ZN forms a frictional force, so as to generate a damping during the rotation. In this way, the display mechanism 200 may rotate in two directions relative to the body mechanism 100 when driven by an external force. When the external force is removed, the display mechanism 200 and the body mechanism 100 may be kept in the current relative positions under an obstruction of the damper bearing ZN, so as to prevent an accident rotation during the use.

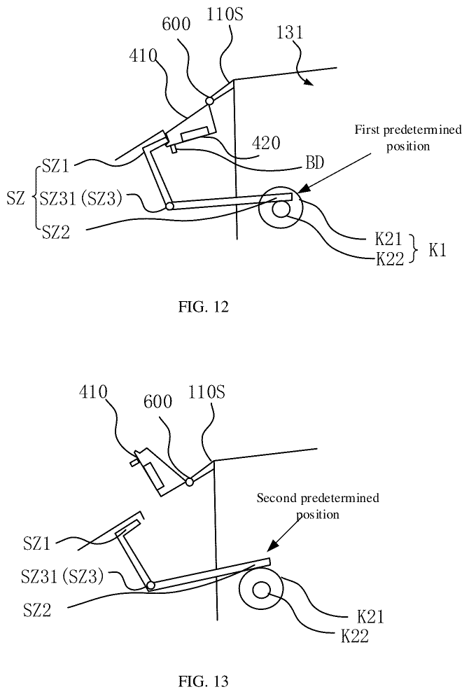

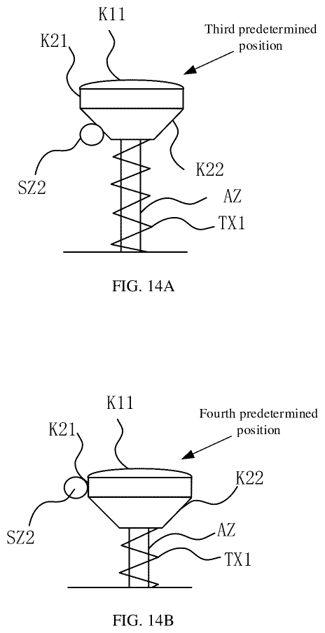

FIG. 12 schematically shows a schematic diagram of a camera mechanism in a first state according to embodiments of the present disclosure, FIG. 13 schematically shows a schematic diagram of a camera mechanism in a second state according to embodiments of the present disclosure, FIG. 14A schematically shows a schematic diagram of a first switch at a third predetermined position according to embodiments of the present disclosure, and FIG. 14B schematically shows a schematic diagram of a first switch at a fourth predetermined position according to embodiments of the present disclosure.

Referring to FIG. 1, FIG. 8 and FIG. 12 to FIG. 14B, in some specific embodiments, the body mechanism 100 includes the third surface 131 and the fourth surface 132 opposite to each other, the first opening 1311 is provided on the third surface 131, and the translation pen further includes: the first switch K1 and a locking member SZ. The first switch K1 is located in the first opening 1311, and a distance between a top end of the first switch K1 and the fourth surface 132 is less than or equal to a distance between the third surface 131 and the fourth surface 132. In this way, in the thickness direction of the body mechanism 100, the top end of the first switch K1 may be parallel to the third surface 131 or lower than the third surface 131, so that the top end of the first switch K1 does not protrude from the third surface 131, thereby preventing an accidental touch on the first switch K1. The locking member SZ is located in the body mechanism 100 and is connected to the first switch K1. The first switch K1 is configured to: drive the locking member SZ to unlock the camera mechanism 400 in response to a pressing operation, so as to allow the state of the camera mechanism 400 to switch from the first state to the second state. The camera mechanism 400 may be controlled to move from an inside of the body mechanism 100 to an outside of the body mechanism 100 through the first switch K1 and the locking member SZ, so as to wake up the camera mechanism to start a scanning-reading operation.

In embodiments of the present disclosure, a shape of the first opening 1311 may be set corresponding to the first switch K1. For example, when the first switch K1 includes a button K11, and a planar shape of the button K11 includes a circle, the first opening 1311 may include a circular opening, so as to facilitate exposing the button K11 of the first switch K1 and allow the button K11 to fit the first opening 1311.

It should be noted that the first opening 1311 may include other shapes, such as a square shape, an oval shape, and the like, which will not be limited in embodiments of the present disclosure.

In some specific embodiments, the camera mechanism 400 includes a camera base 410 and a camera 420, and the camera 420 is embedded in the camera base 410. The camera base 410 includes a third end and a fourth end opposite to each other, the fourth end is rotatably connected to the body mechanism 100 by a third rotation assembly 600, specifically, to the side surface 110S of the body mechanism 100. The third end is used to be locked by the locking member SZ. The third rotation assembly 600 is configured to: allow, when the third end is unlocked from the locking member SZ, the camera base 410 to rotate from an inside of the body mechanism 100 along a rotating shaft of the third rotation assembly 600 until the camera base 410 reaches a designated position outside the body mechanism 100, so as to switch the state of the camera mechanism 400 from the first state to the second state.

In embodiments of the present disclosure, an extension direction of the camera base 410 in the first state is substantially the same as an extension direction of the side surface 110S. The third end and the fourth end of the camera base 410 may refer to two opposite ends of the camera base 410 in the extension direction thereof. The third rotation assembly 600 may include a hinge spring. When the locking member SZ is clamped to the third end of the camera base 410, the camera mechanism 400 may be fixed inside the body mechanism 100. When the locking member SZ unlocks the third end, the hinge spring may rotate the camera base 410 around a rotating shaft of the camera base 410 to the designated position outside the body mechanism 100 under an action of an elastic force. At this time, the camera mechanism 400 is arranged toward the pen head mechanism 500, so that the camera mechanism 400 is in the second state.

Referring to FIG. 8, in some specific embodiments, the camera mechanism 400 includes a camera 420, the pen head mechanism 500 includes a pen head 540, and an optical axis of the camera 420 passes through the pen head 540 when the camera mechanism 400 is in the second state. For example, referring to FIG. 8, the camera 420 is arranged toward the pen head 540, and the optical axis of the camera 420 passes through an upper end of the pen head 540. In this way, a viewing angle range of the camera 420 may cover the pen head 540 and an adjacent region of the pen head 540, so as to prevent a missed scanning. An excessive viewing angle range may be blocked by the pen head mechanism 500 and the body mechanism 100, so as to prevent an excessive scanning.

In some specific embodiments, the locking member SZ may include an electronic locking member. The electronic locking member controls a locking or an unlocking of the camera mechanism 400 by transmitting an electrical signal in response to a trigger instruction of the first switch K1. For example, the electronic locking member may include an electromagnetic lock. Exemplarily, when an electrical signal is not applied to the electromagnetic lock, a lock head extends out under the action of the elastic member such as a spring, etc., so as to lock the camera mechanism 400, and when the electrical signal is applied, the lock head is retracted under an electromagnetic action, so as to achieve a unlocking of the camera mechanism 400.

In other specific embodiments, the locking member SZ may further include a mechanical locking member. Specifically, the translation pen further includes a first mounting column AZ. The first mounting column AZ is fixedly connected to an inner surface of the body mechanism 100, the first mounting column AZ extends in a thickness direction of the body mechanism 100, and the first switch K1 is sleeved on the first mounting column AZ and movable on the first mounting column AZ in an extension direction of the first mounting column AZ. The locking member SZ includes a fifth end SZ1, a sixth end SZ2, and a transmission assembly SZ3 between the fifth end SZ1 and the sixth end SZ2. The sixth end SZ2 abuts the first switch K1 and is movable between a first predetermined position and a second predetermined position with a displacement of the first switch K1. The transmission assembly SZ3 is configured to: clamp the fifth end SZ1 to the camera mechanism 400 for locking when the sixth end SZ2 moves to the first predetermined position, and separate the fifth end SZ1 from the camera mechanism 400 for unlocking when the sixth end SZ2 moves to the second predetermined position.

Referring to FIG. 13, the first predetermined position may refer to a position at which the sixth end SZ2 abuts a second circular truncated cone K22. The second predetermined position may refer to a position at which the sixth end SZ2 abuts a first circular truncated cone K21.

In embodiments of the present disclosure, the first switch K1 may move in the thickness direction of the body mechanism 100 in response to an operation of the user, for example, in response to a pressing operation of the user. The transmission assembly SZ3 may drive the fifth end SZ1 and the sixth end SZ2 of the locking member SZ to move synchronously. For example, when the first switch K1 is pressed by the user, the sixth end SZ2 of the locking member SZ moves toward the second predetermined position with a movement of the first switch K1. When the locking member SZ2 of the locking member SZ starts to move toward the second determined position, the transmission assembly SZ3 may drive the fifth end SZ1 of the locking member SZ to move synchronously. When the sixth end SZ2 moves to the second determined position, the fifth end SZ1 just moves to a position at which the fifth end SZ1 may be separated from the camera mechanism 400.

Accordingly, when the user stops pressing the first switch K1, the first switch K1 may restore to an initial position, and the sixth end SZ2 of the locking member SZ moves toward the first predetermined position with the movement of the first switch K1. When the sixth end SZ2 of the locking member SZ starts to move toward the first predetermined position, the transmission assembly SZ3 may drive the fifth end SZ1 of the locking member SZ to move synchronously. When the sixth end SZ2 moves to the first predetermined position, the fifth end SZ1 just moves to a position at which the fifth end SZ1 may be clamped to the camera mechanism 400.

For an another example, when the sixth end SZ2 of the locking member SZ reaches the first predetermined position (or the second predetermined position), the transmission assembly SZ3 may then drive the fifth end SZ1 to move to a position at which the fifth end SZ1 may be clamped to (or separated from) the camera mechanism 400.

In some specific embodiments, the first switch K1 includes: a button KK1, the first circular truncated cone K21 on a back surface of the button, the second circular truncated cone KK2 on a side of the first circular truncated cone K21 away from the button K11. A front surface of the button KK1 is exposed by the first opening 1311, and the first switch K1 is movable to a third predetermined position and a fourth predetermined position in the extension direction of the first mounting column AZ. A diameter of the second circular truncated cone K22 is less than a diameter of the first circular truncated cone K21. The sixth end SZ2 abuts the second circular truncated cone K22 and is at the first predetermined position when the first switch K1 is at the third predetermined position, and the sixth end SZ2 abuts the first circular truncated cone K21 and is at the second predetermined position when the first switch K1 is at the fourth predetermined position.

The third predetermined position may refer to a position where the first switch K1 moves a maximum distance toward the outside of the body mechanism 100 in an extension direction of the first mounting post AZ. The fourth predetermined position may refer to a position where the first switch K1 moves a maximum distance toward the inside of the body mechanism 100 in the extension direction of the first mounting post AZ.

Optionally, a ratio of the diameter of the first circular truncated cone K21 to the diameter of the second circular truncated cone K22 is greater than or equal to 2:1. For example, the diameter of the first circular truncated cone K21 may be 5 mm, and the diameter of the second circular truncated cone K22 may be 2 mm.

In embodiments of the present disclosure, the button K11 serves as a medium through which the first switch K1 is in a contact with the outside world. When the button K11 is pressed by the user, the button K11, the first circular truncated cone K21, and the second circular truncated cone K22 move as a whole (that is, the first switch K1) in the extension direction of the first mounting post AZ. Referring to FIG. 14A and FIG. 14B, the first switch K1 may move up and down along the first mounting post AZ. When the button K11 is not pressed, the first switch K1 is at the third predetermined position. At this time, the sixth end SZ2 of the locking member SZ abuts the second circular truncated cone K22. When the button K11 is pressed by the user, the first switch K1 moves toward the fourth predetermined position. At this time, the sixth end SZ2 of the locking member SZ is pressed and moves outward. When the first switch K1 reaches the fourth predetermined position, the sixth end SZ2 of the locking member SZ abuts the first circular truncated cone K21, thereby completing a conversion from a vertical displacement to a horizontal displacement.

Optionally, the second circular truncated cone K22 has an arc-shaped side wall, which facilitates a smooth movement of the sixth end SZ2 of the locking member SZ.

In some specific embodiments, the first mounting column AZ is sleeved with a first elastic member TX1, and the first elastic member TX1 is elastically connected to the first switch K1, for example, to the second circular truncated cone K22. The first elastic member TX1 is configured to: allow the first switch K1 to move to the fourth predetermined position in the extension direction of the first mounting column AZ when the first switch K1 is pressed, and allow the first switch K1 to move to the third predetermined position in the extension direction of the first mounting column AZ when the press on the first switch K1 is released. In embodiments of the present disclosure, the first elastic member TX1 may include a spring. When the button K11 is pressed, the first elastic member TX1 may be compressed, so as to allow the first switch K1 to move to the fourth predetermined position. When the press on the button K11 is released, the first elastic member TX1 may restore the first switch K1 to the third predetermined position under an action of an elastic force.

In embodiments of the present disclosure, the camera mechanism 400 ejected to the outside of the body mechanism 100 may be pushed back into the body mechanism 100 by a pressing operation of the user. When the camera mechanism 400 is pushed back into the body mechanism 100, the fifth end SZ1 of the locking member SZ may be at a position where the fifth end is locked with the camera mechanism 400 in advance. The camera base 410 of the camera mechanism 400 may push away the fifth end SZ1 of the locking member SZ, and after the camera base 410 passes, the fifth end SZ1 of the locking member SZ may be rebounded by a rebound structure for a locking with the camera mechanism 400.

In some specific embodiments, the transmission assembly SZ3 includes a rotating shaft SZ31. The sixth end SZ2 rotates around the rotating shaft SZ31 with the displacement of the first switch K1, so as to move between the first predetermined position and the second predetermined position. The fifth end SZ1 rotates around the rotating shaft SZ31 with the displacement of the sixth end SZ2, so as to be clamped to the camera mechanism 400 or to be separated from the camera mechanism 400.

In embodiments of the present disclosure, in the thickness direction of the body mechanism 100, an orthographic projection of the locking member SZ may be substantially U-shaped. Two ends of the U-shaped structure are the fifth end SZ1 and the sixth end SZ2 of the locking member SZ, respectively. One of corners of the U-shaped structure may be the transmission assembly SZ3 of the locking member SZ. The rotating shaft SZ31 is provided at the corner. The rotating shaft SZ31 extends in the thickness direction of the body mechanism 100, so as to allow the fifth end SZ1 and the sixth end SZ2 of the lock member SZ to displace in a horizontal plane perpendicular to the rotating shaft SZ31.

For example, referring to FIG. 12 and FIG. 13, when the user presses the first switch K1, the first switch K1 moves in a direction perpendicular to a vertical plane, the sixth end SZ2 of the locking member SZ moves upward or downward, and the fifth end SZ1 rotates around the rotating shaft SZ31 with a movement of the sixth end SZ2 to move to the left or the right, and is therefore separated from or locked with the camera mechanism 400.

In some specific embodiments, a shape of the pen head mechanism 500 includes a sphere, and a diameter of the pen head mechanism 500 is in a range from 1 mm to 4 mm. For example, the diameter of the pen head mechanism 500 may be set in a range from 2 mm to 3 mm, so as to block the camera mechanism 400 to a certain extent and prevent the camera mechanism 400 from an acquisition of a next line of text of a target line of text, resulting in the excessive scanning.

In some specific embodiments, the designated position is configured to: allow a viewing angle boundary of the camera 420 to cover a target line of text and an end of a previous line of text of the target line of text close to the target line of text. The target line of text includes a line of text adjacent to the pen head mechanism 500 and not obscured by the pen head mechanism 500.

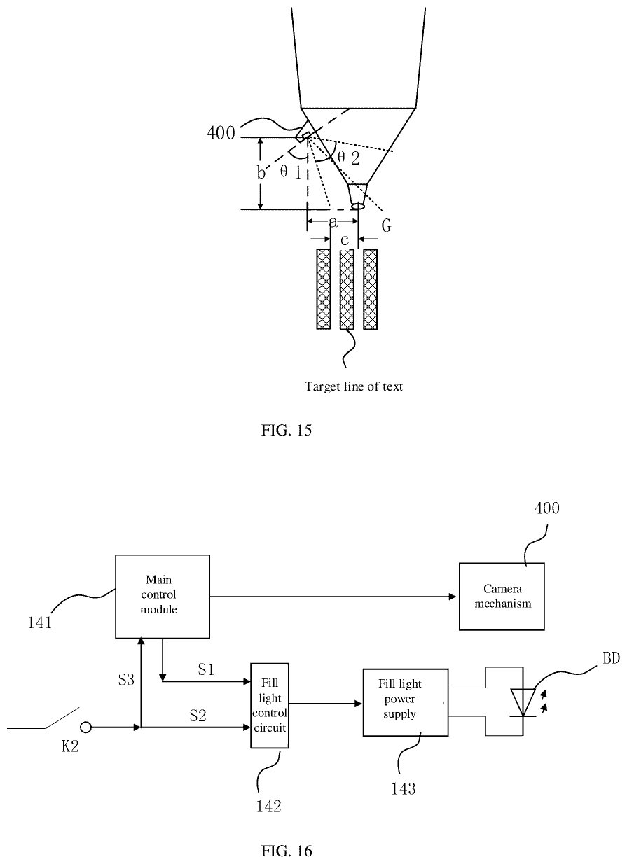

FIG. 15 schematically shows a schematic diagram of a viewing angle boundary of a camera according to embodiments of the present disclosure.

Referring to FIG. 15, in embodiments of the present disclosure, the viewing angle range of the camera mechanism 400 may cover part of the previous line of text of the target line of text, so as to ensure that the camera mechanism 400 may collect a complete information of the target line of text. As only part of the previous line of text of the target line of text is collected, filtering may be performed by a filtering algorithm during an image recognition, so as to retain only the target line of text.

In some specific embodiments, the designated position satisfies: θ1=90°−θ2/2−arctan(a/(b−c)), where θ1 represents a first included angle between a horizontal plane where the camera 420 is located and the axial direction of the body mechanism 100, for example, an acute angle between the horizontal plane where the camera 420 is located and a vertical direction, θ2 represents a viewing angle boundary of the camera 420, a represents a horizontal distance between the camera 420 and the pen head mechanism 500, b represents a vertical distance between the camera 420 and a top end of the pen head mechanism 500, and c represents a configurable value. A value range of c may be from 6.5 mm to 8 mm. For example, c may be 7.25 mm, which is set according to a font size.

For example, it is assumed that the text uses 12 point front, a letter height of about 3.5 mm and a word spacing of 2.5 mm. The viewing angle range of the camera mechanism 400 is 64°. During the scanning-reading, in order to prevent an error of content recognition caused by scanning multiple lines of content, the maximum scanning range of the camera mechanism 400 may only fall at the bottom of the previous line of text. Taking the pen head mechanism 500 of the translation pen as a reference, it is assumed that a horizontal distance between a central position of the camera mechanism 400 and the top end of the pen head mechanism 500 is a, and a vertical distance between the central position of the camera mechanism 400 and the top end of the pen head mechanism 500 is b. c is specifically a letter height+1.5 word spacing, which is about 7.25 mm. θ2=arctan(a/b−7.25), and θ1=90°−64°/2−θ2=58°−arctan(a/b−7.25). According to the above equations, after the value a, the value b, and the value c are determined, an angle θ1 between a circular truncated cone of the camera base 410 of the camera mechanism 400 and the vertical direction may be obtained.

In embodiments of the present disclosure, a side-mounted camera mechanism 400 does not block the scanning-reading path, and it is more in line with a conventional reading system for the user to point at a lower part of the target line of text by the pen head mechanism 500. At the same time, compared with the camera mechanism 400 below the pen head mechanism 500, the separation of the side-mounted camera mechanism 400 and the pen head mechanism 500 is more beneficial to reducing the thickness of the body mechanism 100.

It should be noted that, although part of corners of the translation pen in FIG. 1 to FIG. 15 are right angles, this does not constitute a limitation on embodiments of the present disclosure. For example, the corner of the translation pen in embodiments of the present disclosure may be an arc angle, so as to improve a safety in use and reduce a damage caused by a bumping.

A circuit structure of the translation pen in embodiments of the present disclosure will be described below.

In a comparative example, the translation pen further includes a fill light lamp, a fill light power supply and a main control module. When an image acquisition instruction is received, the main control module generates a fill light control signal and transmits the fill light control signal to the fill light power supply. The fill light power supply generates a drive signal according to the received fill light control signal, so as to drive the fill light lamp to fill light.

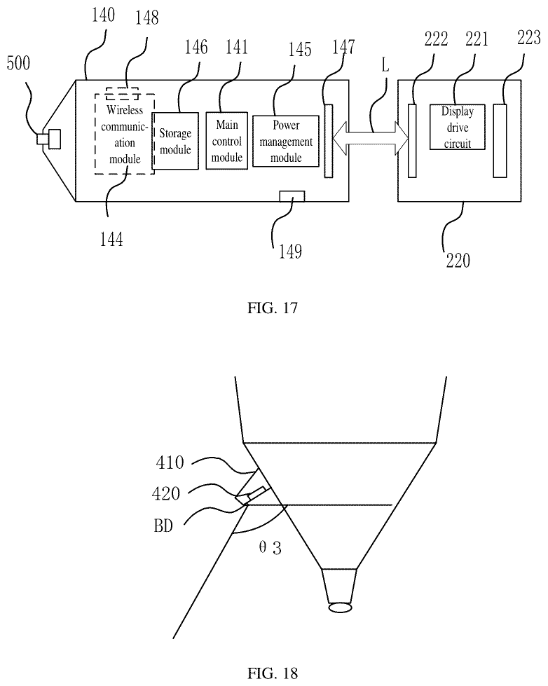

FIG. 16 schematically shows a circuit diagram of controlling a fill light lamp according to embodiments of the present disclosure, FIG. 17 schematically shows a circuit diagram of a translation pen according to embodiments of the present disclosure, and FIG. 18 schematically shows a circuit diagram of a fill light lamp according to embodiments of the present disclosure.

Referring to FIG. 16 to FIG. 18, in some specific embodiments, the body mechanism 100 includes a main board 140 and a contact switch K2, the pen head mechanism 500 is movable between a fifth predetermined position and a sixth predetermined position in the axial direction of the body mechanism 100, or the pen head mechanism 500 may be extended and retracted in the axial direction of the body mechanism 100. The main board 140 includes a main control module 141 and a fill light control circuit 142 electrically connected to the main control module 141, the camera mechanism 400 further includes a fill light lamp BD, and the fill light lamp BD is electrically connected to the fill light control circuit 142. The main control module 141 is configured to: output a first control signal S1 to the fill light control circuit 142 when the translation pen is woken up. The pen head mechanism 500 is electrically connected to the contact switch K2, and the contact switch K2 is configured to: output a second control signal S2 to the light fill control circuit 142 when the pen head mechanism 500 moves to the fifth predetermined position. The fill light control circuit 142 is configured to: control the fill light lamp BD to be turned on when the first control signal S1 and the second control signal S2 are received.

The fifth predetermined position may refer to a position where the pen head mechanism is located after being extended out of the body mechanism 100. The sixth predetermined position may refer to a position where the pen head mechanism is located after being retracted into the body mechanism 100.

In embodiments of the present disclosure, waking up the translation pen may refer to a power-on operation of the translation pen, or the like. When the translation pen is woken up, the main control module 141 directly outputs the first control signal S1 to the fill light control circuit 142, which corresponds to an operation of allowing the main control module 141 to generate the first control signal S1 in advance before the fill light lamp BD is turned on. The fill light control circuit 142 may include a logic AND gate circuit. The logic AND gate circuit may not control the fill light lamp BD to be turned on when the second control signal S2 is not received, thereby preventing the fill light lamp BD from being accidentally turned on due to an accidental touch on the pen head mechanism 500. When an external pressure is not applied to the pen head mechanism 500, the pen head mechanism 500 may be located at the sixth predetermined position. When the external pressure is applied to the pen head mechanism 500, the pen head mechanism 500 may be retracted into the body mechanism 100 to move to the fifth predetermined position. When the pen head mechanism 500 moves to the fifth predetermined position, the contact switch K2 may be controlled to be turned off, thereby outputting the second control signal S2 to the light fill control circuit 142. When receiving the first control signal S1 and the second control signal S2 simultaneously, the fill light control circuit 142 outputs a power-on signal to the fill light power supply 143. The fill light power supply 143 supplies power to the fill light lamp BD, so as to drive the fill light lamp BD to be turned on.

Compared with the solution of the comparative example that the main control module 141 generates the fill light control signal when the image acquisition is received, in embodiments of the present disclosure, the main control module 141 may generate the first control signal S1 in advance through two paths of control signals before the image acquisition instruction (that is, the second control signal S2) is received. In this way, the drive signal generated by the fill light power supply 143 may reach a stable state more quickly, so that a brightness of the fill light lamp BD may be stabilized more quickly, which may achieve a better imaging effect of the camera mechanism 400.

In embodiments of the present disclosure, the fill light lamp BD may be an LED light, and the fill light power supply 143 may be an LED driver.

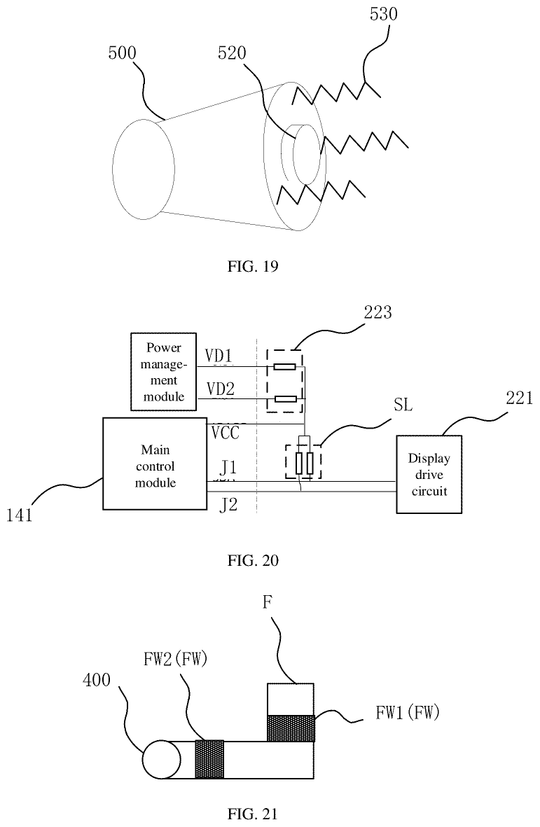

FIG. 19 schematically shows a schematic diagram of a pen head mechanism according to embodiments of the present disclosure.

Referring to FIG. 19, in some specific embodiments, a convex portion 520 and a second elastic member 530 at least partially surrounding the convex portion 520 are provided between the pen head mechanism 500 and the contact switch K2. The second elastic member 530 is configured to: when an external pressure is applied to the pen head mechanism 500, allow the pen head mechanism 500 to move to the fifth predetermined position and bring the convex portion 520 into contact with the contact switch K2, so that the contact switch K2 outputs the second control signal S2 to the fill light control circuit 142, and when the external pressure is relieved, restore the pen head mechanism 500 into the sixth predetermined position.

In embodiments of the present disclosure, the second elastic member 530 may include a spring. When the pen head mechanism 500 is pressed, the second elastic member 530 may be compressed, so that the convex portion 520 may be in contact with the contact switch K2. When the press on the pen head mechanism 500 is released, the second elastic member 530 is restored to an initial state, so that the convex portion 520 may be separated from the contact switch K2 and restored into the sixth predetermined position under an action of an elastic force.

Optionally, the second elastic member 530 surrounds the convex portion 520, which may play a role of limiting and supporting, and at the same time is beneficial to deploying enough and evenly distributed second elastic members 530 in a narrow space formed by the convex portion 520 and the contact switch K2, so as to meet needs of the elastic force.

In some specific embodiments, the contact switch K2 is further configured to: output a third control signal S3 to the main control module 141 when the pen head mechanism 500 is pressed to the fifth predetermined position. The main control module 141 is further configured to: wake up the camera mechanism 400 in response to the third control signal S3, so as to start an acquisition of an image; and confirm a completion of the acquisition in response to an interruption of the third control signal S3.

In embodiments of the present disclosure, the contact switch K2 is electrically connected to a touch control module and the fill light control circuit 142 simultaneously. After the convex portion 520 on the pen head mechanism 500 is in the contact with the contact switch K2, the contact switch K2 provides the third control signal S3 to the main control module 141 while providing the second control signal S2 to the fill light control circuit 142. since the first control signal S1 is generated prior to the third control signal S3, the first control signal S1 may reach the fill light power supply 143 first, and the third control signal S3 may reach the camera mechanism 400 later. This may allow the fill light lamp BD to be turned on prior to the camera mechanism 400, so that the fill light lamp BD may reach a state of stable brightness before the camera mechanism 400 is turned on. The camera mechanism 400 may be turned on and start the acquisition of the image when the fill light lamp BD is in a stable state, which is beneficial to improving an effect of image recognition.

Referring to FIG. 18, in some specific embodiments, the camera mechanism 400 further includes the camera 420, and a divergence angle θ3 of the fill light lamp BD is greater than or equal to 100°. For example, the divergence angle θ3 of the fill light lamp BD is greater than 120°, so as to cover the viewing angle range of the camera mechanism 400. In some specific embodiments, the fill light lamp BD and the camera 420 are formed into an integral structure. A distance between the fill light lamp BD and the camera 420 is greater than or equal to 0.8 mm. For example, the distance between the fill light lamp BD and the camera 420 is greater than 1 mm, so as to meet needs of a molding accuracy.

In some specific embodiments, the main board 140 further includes: a wireless communication module 144 electrically connected to the main control module 141, a power management module 145, a storage module 146, and a first adapter 147. The wireless communication module 144 is located on a different side of the main board 140 from the main control module 141, and the power management module 145, the storage module 146 and the first adapter 147 are located on a same side of the main board 140 as the main control module 141. The display mechanism 200 includes a screen drive board 220, the screen drive board 220 includes a display drive circuit 221 and a second adapter 222 electrically connected to the display drive circuit 221, and the display drive circuit 221 is located on a same side of the screen drive board 220 as the second adapter 222. The first adapter 147 is electrically connected to the second adapter 222 by an adapter harness L.

In embodiments of the present disclosure, the power management module 145, the storage module 146, and the first adapter 147 are located on a same side of the main board 140 as the main control module 141, so as to reduce the thickness of the body mechanism 100. Optionally, the body mechanism 100 further includes a wireless communication transceiver mechanism. The wireless communication transceiver mechanism may include, for example, an antenna, a coil, etc., so that the wireless communication module 144 may be located on a same side of the main board 140 as the wireless communication transceiver mechanism (e.g., the coil). On the one hand, two opposite surfaces of the main board 140 may be fully utilized, and on the other hand, the wireless communication module 144 and the wireless communication transceiver mechanism may be disposed adjacent to each other, so as to avoid an interference caused by an electrical signal of other elements.

FIG. 20 schematically shows a schematic diagram of providing a first power supply voltage and a second power supply voltage by a power management module according to embodiments of the present disclosure.

Referring to FIG. 20, in some specific embodiments, the power management module 145 provides a first power supply voltage VD1 and a second power supply voltage VD2, and a magnitude of the first power supply voltage VD1 is different from a magnitude of the second power supply voltage VD2. The screen drive board 220 further includes: a level compatible circuit 223 connected between the second adapter 222 and the display drive circuit 221. The level compatible circuit 223 is configured to: provide one of the first power supply voltage VD1 and the second power supply voltage VD2 to a pull-up power supply SL of a data signal J1 and a clock signal J2 in the display drive circuit 221 and a communication power supply VCC of the main control module 141.

Optionally, the main board 140 may further include a data interface 149, such as a USB data interface, etc., which may be determined according to actual needs, and will not be limited in the present disclosure.

In embodiments of the present disclosure, the body mechanism 100 and the display mechanism 200 use a split design. The display mechanism 200 may be replaced according to actual needs. For example, when different display screens PA are used, the number of connector pins, a definition of the pin, and a backlight voltage and current thereof may be also different. In order to adapt to different display screens PAs, in embodiments of the present disclosure, at least two power supply voltages are provided to the power management module 145. For example, the first power supply voltage VD1 may include 3.3 V, and the second power supply voltage VD2 may include 1.8 V. Exemplarily, a signal provided from the main control module 141 to the display screen PA needs to pass through the pull-up power supply SL, so that the signal provided to the display screen PA may meet needs of a signal input interface thereof. The signal input interfaces of different display screens PAs have different needs. Therefore, different pull-up power supplies SLs are required. In embodiments of the present disclosure, one of the first power supply voltage VD1 and the second power supply voltage VD2 may be selected as the pull-up power supply SL or provided to the pull-up power supply SL according to actual needs, so that the pull-up power supply SL may meet needs of at least two kinds of display screens PAs.

In embodiments of the present disclosure, different display screens PAs need to be matched with the main board 140 in the body mechanism 100, which is specifically reflected in a problem of power supply voltage in a communication between the main control module 141 and the display screen PA. For example, the main control module 141 communicates with the display screen PA based on an I2C communication protocol, and different display screens PAs have different needs for the I2C signal (that is, the data signal and the clock signal) output from the main control module 141. One of the first power supply voltage VD1 and the second power supply voltage VD2 may be selected and provided to the pull-up power supply SL of the data signal J1 and the clock signal J2 by the level compatible circuit 223, so that the I2C signal output from the main control module 141 may be adapted to the display screen PA. In order to match a hardware power supply of the main control module 141 with the I2C signal provided to the display screen PA, in embodiments of the present disclosure, one of the first power supply voltage VD1 and the second power supply voltage VD2 (which is specifically the same as the voltage provided to the pull-up power supply) may be selected and provided to the communication power supply VCC of the main control module 141 by the level compatible circuit 223. In this way, when a different display screen PA is replaced for the translation pen, an adaptation of the display screen PA to the main control module 141 may be achieved by the level compatible circuit 223.

In embodiments of the present disclosure, the first power supply voltage VD1 and the second power supply voltage VD2 provided by the power management module 145 may be returned to the body mechanism 100 by the second adapter 222 and the first adapter 147 after being selected by the level compatible circuit 223, and may be electrically connected to a communication power supply of the main control module 141 in the body mechanism 100.

In embodiments of the present disclosure, the level compatible circuit 223 includes a 0 ohm resistor. The 0 ohm resistor may be used as a jumper, which is selectively welded to a power supply line of one of the first power supply voltage VD1 and the second power supply voltage VD2, thereby achieving a selective power supply.

In some specific embodiments, in an axial direction of the display mechanism 200, the second adapter 222 is located on a side of the display drive circuit 221 close to the rotation mechanism 300, and the level compatible circuit 223 is located on a side of the display drive circuit 221 far away from the second adapter 222. In this way, the level compatible circuit 223 and the display drive circuit 221 may be disposed in a close proximity to each other. Therefore, a transmission distance of a signal output from the level compatible circuit 223 is short, thereby avoiding an interference of other signals and preventing a display of the display screen PA from being affected.

Through the above-mentioned method, not only an area of the main board 140 in the body mechanism 100 may be reduced, but also it is not required to change the main board 140 in the body mechanism 100 when the screen is replaced, thereby reducing a hardware replacement cost. as for a common broken screen problem of an electronic product, the user may purchase a display assembly for a replacement voluntarily, which is more convenient for replacement and may reduce a after-sales cost.

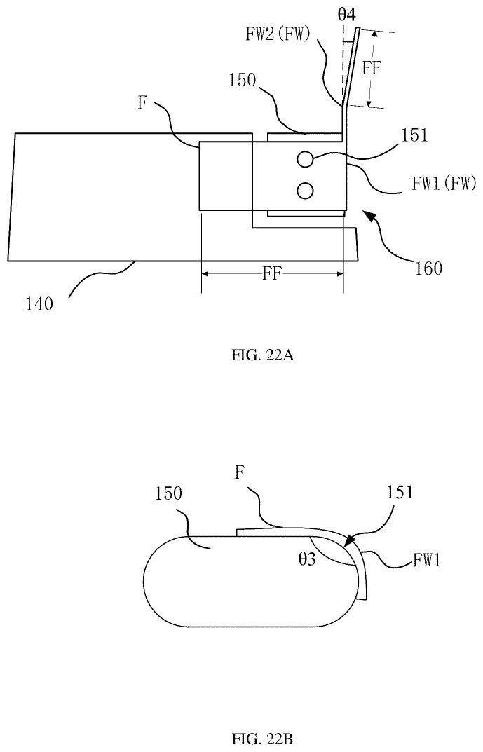

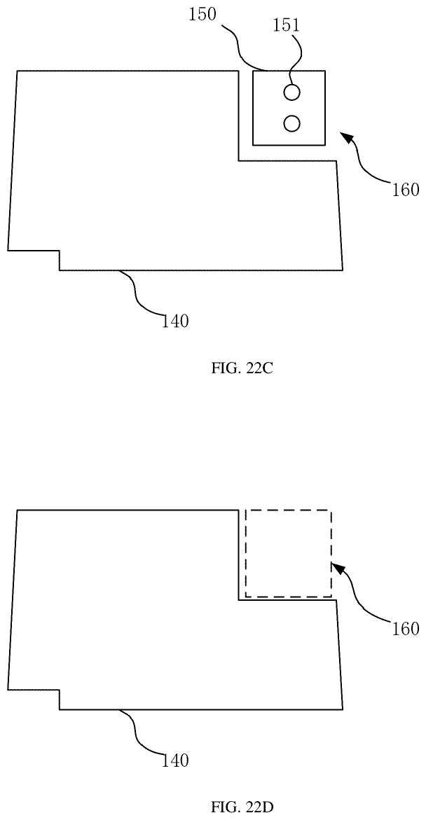

FIG. 21 schematically shows a schematic diagram of a flexible circuit board according to embodiments of the present disclosure, FIG. 22A schematically shows a schematic diagram of a main board, a flexible circuit board and a fixing structure according to embodiments of the present disclosure, FIG. 22B schematically shows a schematic diagram of fitting a first bending region and a first curved surface according to embodiments of the present disclosure, FIG. 22C schematically shows a schematic diagram of exposing a fixing structure by a second opening according to embodiments of the present disclosure, and FIG. 22D schematically shows a schematic diagram of a second opening according to embodiments of the present disclosure.

Referring to FIG. 21 to FIG. 22D, in some embodiments, the main board 140 further includes a camera mechanism connector 148. The camera mechanism connector 148 is disposed on a different side of the main board from the main control module 141. The camera mechanism connector 148 is electrically connected to the camera mechanism 400 by a flexible circuit board F. The flexible circuit board F includes at least one bending region FW. The bending region FW includes a grid structure. The grid structure may effectively reduce a stress concentration in the bending region FW, and avoid a problem such as a fracture of the flexible circuit board F during a bending process or in a case of a long-term bending. A material in the bending region includes a rolled copper. The rolled copper is a conductive material having a ductility. The conductive material of the bending zone FW prepared with the material is beneficial to the bending of the flexible circuit board F.

In some specific embodiments, the flexible circuit board F further includes a non-bending region FF located outside the bending region FW. The non-bending region FF and the bending region FW are arranged alternately. The non-bending region FF is disposed substantially in a straight line. A wiring is provided on a side surface of the bending region FW, and a wiring is provided on each of two side surfaces of the non-bending region FF. In embodiments of the present disclosure, a single-sided wiring is used in the bending region FW domain, so as to reduce a number and a thickness of the wiring in the bending region FW and reduce a bending stress in the bending region FW, thereby avoiding a fracture. In other regions of the flexible circuit board F, a double-sided wiring may be used to improve a space utilization.

In some specific embodiments, the at least one bending region FW includes a first bending region FW1 and a second bending region FW2, and the second bending region FW2 is located between the first bending region FW1 and the camera mechanism 400. A bending angle θ3 of the first bending region FW1 is greater than a bending angle θ4 of the second bending region FW2.

The body mechanism 100 further includes a fixing structure 150 fixedly connected to an inner surface of the body mechanism 100, the main board 140 further includes a second opening 160, the second opening 160 is configured to expose the fixing structure 150, and the first bending region FW1 is fixedly connected to the fixing structure 150 by the second opening 160. The fixing structure 150 includes a first curved surface 151, and the first curved surface 151 substantially fits the first bending region FW1. Referring to FIG. 22B, the first curved surface 151 has a certain radian. A bending radian of the first bending region FW1 is substantially the same as a radian of the first curved surface 151, so that the first bending region FW1 may be bent with a certain radian against the first curved surface 151. Compared with a right-angle bending, the bending with a radian may alleviate a problem of stress concentration so as to prevent a fracture.

In embodiments of the present disclosure, the camera mechanism 400 and the main board 140 are perpendicular to each other. The flexible circuit board F needs to be bent in two directions and then connected to the camera mechanism 400. In the first bending region FW1, the flexible circuit board F needs to be bent by about 90° in a thickness direction of the main board 140. In order to ensure a bending stability of the flexible circuit board F, the main board 140 is provided with the second opening 160 at a corresponding position to avoid a collision. At the same time, the fixing structure 150 is provided at the position to fix the flexible circuit board F to an inner surface of the main structure.

In addition, a side wall of the fixing structure 150 may be designed as a curved surface, so as to allow the first bending region FW1 of the flexible circuit board F to better fit the side wall, thereby preventing a damage to the flexible circuit board F caused by a bending (a dead bending) at a large angle. After the flexible circuit board F passes through the first bending region FW1, the flexible circuit board F needs to be fine-tuned in angle when passing through the second bending region FW2, so as to be better electrically connected to the camera mechanism 400.

In some specific embodiments, the fixing structure 150 includes a plurality of positioning columns 151. The flexible circuit board F is correspondingly provided with an opening. Therefore, the opening on the flexible circuit board F is sleeved on the positioning column 151, so as to achieve a fixed connection between the flexible circuit board F and the fixing structure 150. The fixing structure 150 may prevent the flexible circuit board F from falling off during vibration.

It should be noted that, although the above-mentioned embodiments have been described by taking the vertically placed translation pen as an example, this does not constitute a limitation on the use and the placement of the translation pen in embodiments of the present disclosure. The translation pen provided in embodiments of the present disclosure may be placed and used at any angle according to use needs of the user.

In embodiments of the present disclosure, the display screen PA in the display mechanism 200 may include a liquid crystal display panel or an organic electroluminescent display panel. Exemplarily, the display screen PA may include a liquid crystal display panel, and the liquid crystal display panel may use an LED lamp as a backlight source.

Although some embodiments of the general technical concept of the present disclosure have been shown and described, those ordinary skilled in the art may understand that changes may be made to these embodiments without departing from the principle and spirit of the general technical concept, and the scope of the present disclosure is defined by the claims and their equivalents.

1. A translation pen, comprising:
a body mechanism, comprising a first end and a second end opposite to each other;
a display mechanism;
a rotation mechanism, comprising a first rotation assembly and a second rotation assembly connected to the first rotation assembly, wherein the first rotation assembly is connected to the display mechanism, the second rotation assembly is connected to the first end of the body mechanism, an axial direction of a rotating shaft of the second rotation assembly is the same as an axial direction of the body mechanism, an axial direction of a rotating shaft of the first rotation assembly is intersected with the axial direction of the rotating shaft of the second rotation assembly, and the rotation mechanism is configured to: allow the display mechanism to rotate along the rotating shaft of the first rotation assembly relative to the body mechanism, and allow the display mechanism to rotate along the rotating shaft of the second rotation assembly relative to the body mechanism;
a camera mechanism on a side surface of the body mechanism, wherein a state of the camera mechanism comprises a first state and a second state, the camera mechanism in the first state is located inside the body mechanism, and the camera mechanism in the second state is located outside the body mechanism; and
a pen head mechanism connected to the second end of the body mechanism, wherein the camera mechanism in the second state is arranged toward the pen head mechanism.

2. The translation pen according to claim 1, wherein the display mechanism comprises a first surface and a second surface opposite to each other, and a display screen is provided on the first surface;
the first rotation assembly is connected to the second surface, and the display mechanism and the body mechanism are foldable and deployable along the rotating shaft of the first rotation assembly; and
wherein when the display mechanism and the body mechanism are in a folded state, the body mechanism is located on a side of the second surface away from the first surface, and in a thickness direction of the body mechanism, an orthographic projection of a top end of the pen head mechanism does not overlap with an orthographic projection of the second surface.

3. The translation pen according to claim 2, wherein when the display mechanism and the body mechanism are in the folded state, an orthographic projection of the body mechanism on the second surface is spaced apart from an orthographic projection of the first rotation assembly on the second surface, and a distance between a surface of the body mechanism away from the display mechanism and the display mechanism is greater than a distance between an axis of the rotating shaft of the first rotation assembly and the display mechanism.

4. The translation pen according to claim 1, wherein the rotation mechanism further comprises a support frame, the first rotation assembly comprises a first shaft body and a second shaft body, and the second rotation assembly comprises a third shaft body;
the first shaft body and the second shaft body are fixedly connected to the display mechanism, and the third shaft body is fixedly connected to the body mechanism; and
at least one of the first shaft body, the second shaft body, and the third shaft body is rotatably connected to the support frame by a damper bearing, wherein the first shaft body and the second shaft body are located on two opposite sides of the support frame, respectively, and the third shaft body is located on a different side of the support frame from the first shaft body and the second shaft body.

5. The translation pen according to claim 1, wherein the first end of the body mechanism comprises a first inclined portion, a thickness of the first inclined portion gradually decreases in a direction pointing from the second end toward the first end, a side of the first inclined portion away from the second end abuts the display mechanism when the display mechanism and the body mechanism are in a deployed state, and the body mechanism is substantially parallel to the display mechanism.

6. The translation pen according to claim 4, wherein the damper bearing is embedded in the support frame; and
the damper bearing and the support frame are formed into an integral structure; or the damper bearing and the supporting frame are fixedly connected by a buckle structure.

7. The translation pen according to claim 4, wherein at least one of the first shaft body, the second shaft body, and the third shaft body comprises a protrusion portion, the protrusion portion protrudes into the damper bearing and forms an interference fit with the damper bearing.

8. The translation pen according to claim 1, wherein the body mechanism comprises a third surface and a fourth surface opposite to each other, a first opening is provided on the third surface, and the translation pen further comprises:
a first switch in the first opening, wherein a distance between a top end of the first switch and the fourth surface is less than or equal to a distance between the third surface and the fourth surface; and
a locking member in the body mechanism, wherein the locking member is connected to the first switch;
wherein the first switch is configured to drive the locking member to unlock the camera mechanism in response to a pressing operation, so as to allow the state of the camera mechanism to switch from the first state to the second state.

9. The translation pen according to claim 8, wherein the camera mechanism comprises a camera base and a camera, and the camera is embedded in the camera base;
the camera base comprises a third end and a fourth end opposite to each other, the fourth end is rotatably connected to the body mechanism by a third rotation assembly, and the third end is configured to be locked by the locking member; and
the third rotation assembly is configured to: allow, when the third end is unlocked from the locking member, the camera base to rotate from an inside of the body mechanism along a rotating shaft of the third rotation assembly until the camera base reaches a designated position outside the body mechanism, so as to switch the state of the camera mechanism from the first state to the second state.

10. The translation pen according to claim 8, wherein the translation pen further comprises a first mounting column, wherein the first mounting column is fixedly connected to an inner surface of the body mechanism, the first mounting column extends in a thickness direction of the body mechanism, and the first switch is sleeved on the first mounting column and movable on the first mounting column in an extension direction of the first mounting column;
the locking member comprises a fifth end, a sixth end, and a transmission assembly between the fifth end and the sixth end, the sixth end abuts the first switch and is movable between a first predetermined position and a second predetermined position with a displacement of the first switch; and
the transmission assembly is configured to: clamp the fifth end to the camera mechanism for locking when the sixth end moves to the first predetermined position, and separate the fifth end from the camera mechanism for unlocking when the sixth end moves to the second predetermined position.

11. The translation pen according to claim 10, wherein the first switch comprises: a button, wherein a front surface of the button is exposed by the first opening, and the first switch is movable to a third predetermined position and a fourth predetermined position in the extension direction of the first mounting column;
a first circular truncated cone on a back surface of the button; and
a second circular truncated cone on a side of the first circular truncated cone away from the button, and a diameter of the second circular truncated cone is less than a diameter of the first circular truncated cone; and
the sixth end abuts the second circular truncated cone and is at the first predetermined position when the first switch is at the third predetermined position, and the sixth end abuts the first circular truncated cone and is at the second predetermined position when the first switch is at the fourth predetermined position.

12. The translation pen according to claim 10, wherein the first mounting column is sleeved with a first elastic member, the first elastic member is elastically connected to the first switch, and the first elastic member is configured to: allow the first switch to move to a fourth predetermined position in the extension direction of the first mounting column when the first switch is pressed, and allow the first switch to move to a third predetermined position in the extension direction of the first mounting column when the press on the first switch is released.

13. The translation pen according to claim 10, wherein the transmission assembly comprises a rotating shaft, and the sixth end rotates around the rotating shaft with the displacement of the first switch, so as to move between the first predetermined position and the second predetermined position; and
the fifth end rotates around the rotating shaft with a displacement of the sixth end, so as to be clamped to the camera mechanism or to be separated from the camera mechanism.

14. The translation pen according to claim 1, wherein a shape of the pen head mechanism comprises a sphere, and a diameter of the pen head mechanism is in a range from 1 mm to 4 mm.

15. The translation pen according to claim 9, wherein the designated position is configured to: allow a viewing angle boundary of the camera to cover a target line of text and an end of a previous line of text of the target line of text close to the target line of text;
wherein the target line of text comprises a line of text adjacent to the pen head mechanism and not obscured by the pen head mechanism-,
wherein the designated position satisfies:
θ1=90°−θ2/2−arctan(a/(b−c));
where θ1 represents a first included angle between a horizontal plane where the camera is located and the axial direction of the body mechanism, θ2 represents a viewing angle boundary of the camera, a represents a horizontal distance between the camera and the pen head mechanism, b represents a vertical distance between the camera and a top end of the pen head mechanism, and c represents a configurable value, wherein a range of value of c is from 6.5 mm to 8 mm.

16. (canceled)

17. The translation pen according to claim 1, wherein the body mechanism comprises a main board and a contact switch, the pen head mechanism is movable between a fifth predetermined position and a sixth predetermined position in the axial direction of the body mechanism;
the main board comprises a main control module and a fill light control circuit electrically connected to the main control module, the camera mechanism further comprises a fill light lamp, and the fill light lamp is electrically connected to the fill light control circuit;
the main control module is configured to: output a first control signal to the fill light control circuit when the translation pen is woken up;
the pen head mechanism is electrically connected to the contact switch, and the contact switch is configured to: output a second control signal to the light fill control circuit when the pen head mechanism moves to the fifth predetermined position; and
the fill light control circuit is configured to: control the fill light lamp to be turned on when the first control signal and the second control signal are received.

18. The translation pen according to claim 17, wherein a convex portion and a second elastic member at least partially surrounding the convex portion are provided between the pen head mechanism and the contact switch; and
the second elastic member is configured to: when an external pressure is applied to the pen head mechanism, allow the pen head mechanism to move to the fifth predetermined position and bring the convex portion into contact with the contact switch, so that the contact switch outputs the second control signal to the fill light control circuit; and when the external pressure is relieved, restore the pen head mechanism to the sixth predetermined position;
wherein the contact switch is further configured to: output a third control signal to the main control module when the pen head mechanism is pressed into the fifth predetermined position; and the main control module is further configured to: wake up the camera mechanism in response to the third control signal, so as to start an acquisition of an image; and confirm a completion of the acquisition in response to an interruption of the third control signal.

19. (canceled)

20. The translation pen according to claim 17, wherein the camera mechanism further comprises a camera, a divergence angle of a fill light lamp is greater than or equal to 100°, and a distance between the fill light lamp and the camera is greater than or equal to 0.8 mm;
wherein the camera mechanism comprises a camera, the pen head mechanism comprises a pen head, and an optical axis of the camera passes through the pen head when the camera mechanism is in the second state.

21. The translation pen according to claim 17, wherein the main board further comprises: a wireless communication module electrically connected to the main control module, a power management module, a storage module, and a first adapter, the wireless communication module is located on a different side of the main board from the main control module, and the power management module, the storage module and the first adapter are located on a same side of the main board as the main control module;
the display mechanism comprises a screen drive board, the screen drive board comprises a display drive circuit and a second adapter electrically connected to the display drive circuit, and the display drive circuit and the second adapter are located on a same side of the screen drive board; and
the first adapter is electrically connected to the second adapter by an adapter harness;
wherein the power management module provides a first power supply voltage and a second power supply voltage, a magnitude of the first power supply voltage is different from a magnitude of the second power supply voltage; the screen drive board further comprises: a level compatible circuit connected between the second adapter and the display drive circuit; and the level compatible circuit is configured to: provide one of the first power supply voltage and the second power supply voltage to a pull-up power supply of a data signal and a clock signal in the display drive circuit and a communication power supply of the main control module;
wherein in an axial direction of the display mechanism, the second adapter is located on a side of the display drive circuit close to the rotation mechanism, and the level compatible circuit is located on a side of the display drive circuit far away from the second adapter.

22. (canceled)

23. (canceled)

24. The translation pen according to claim 17, wherein the main board further comprises a camera mechanism connector, and the camera mechanism connector is electrically connected to the camera mechanism by a flexible circuit board; and
the flexible circuit board comprises at least one bending region, the bending region comprises a grid structure, and a material in the bending region comprises a rolled copper;
wherein the flexible circuit board further comprises a non-bending region outside the bending region, a wiring is provided on a side surface of the bending region, and a wiring is provided on each of two side surfaces of the non-bending region;
wherein the at least one bending region comprises a first bending region and a second bending region, the second bending region is located between the first bending region and the camera mechanism, and a bending angle of the first bending region is greater than a bending angle of the second bending region; the body mechanism further comprises a fixing structure fixedly connected to an inner surface of the body mechanism, the main board further comprises a second opening, the second opening is configured to expose the fixing structure, and the first bending region is fixedly connected to the fixing structure by the second opening; and wherein the fixing structure comprises a first curved surface, and the first curved surface substantially fits the first bending region.

25. (canceled)

26. (canceled)

27. (canceled)
